(19) United States
(12) Patent Application Publication
(10) Pub. No.: US 2018/0229497 A1
(43) Pub. Date: Aug. 16, 2018

(54) PRECISION POSITION ALIGNMENT, CALIBRATION AND MEASUREMENT IN PRINTING AND MANUFACTURING SYSTEMS

(71) Applicant: Kateeva, Inc., Newark, CA (US)

(72) Inventors: David C. Darrow, Pleasanton, CA (US); Christopher Buchner, Sunnyvale, CA (US); Robert B. Lowrance, San Jose, CA (US); Kevin John Li, Mountain View, CA (US)

(21) Appl. No.: 15/851,419

(22) Filed: Dec. 21, 2017

Related U.S. Application Data
(60) Provisional application No. 62/459,402, filed on Feb. 15, 2017.

(51) Int. Cl. B41J 2/045

(52) U.S. Cl. CPC B41J 2/04505; B41J 2/04586

(57) ABSTRACT

This disclosure provides a high precision measurement system for rapid, accurate determination of height of a deposition source relative to a deposition target substrate. In one embodiment, each of two transport paths of an industrial printer mounts a camera and a high precision sensor. The cameras are used to achieve registration between split transport axes, and the positions of the high precision sensors are each precisely determined in terms of xy position. One of the high precision sensors is used to measure height of the deposition source, while another measures height of the target substrate. Relative z axis position between these sensors is identified to provide for precise z-coordinate identification of both source and target substrate. Disclosed embodiments permit dynamic, real-time, high precision height measurement to micron or submicron accuracy.

This application claims the benefit of U.S. Provisional Patent Application No. 62/459,402, filed as an application on Feb. 15, 2017 on behalf of first-named inventor David C. Darrow for “Precision Position Alignment, Calibration And Measurement In Printing And Manufacturing Systems;” this provisional application is hereby incorporated by reference. This application also incorporates by reference the following documents: (1) U.S. Pat. No. 9,352,561 (U.S. Ser. No. 14/340,403), filed as an application on Jul. 24, 2014 on behalf of first-named inventor Nahid Harjee for “Techniques for Print Ink Droplet Measurement and Control to Deposit Fluids within Precise Tolerances,” (2) US Patent Publication No. 20150298153 (U.S. Ser. No. 14/788,609), filed as an application on Jun. 30, 2015 on behalf of first-named inventor Michael Baker for “Techniques for Arrayed Printing of a Permanent Layer with Improved Speed and Accuracy,” and (3) U.S. Pat. No. 8,995,022, filed as an application on Aug. 12, 2014 on behalf of first-named inventor Eliyahu Vronsky for “Ink-Based Layer Fabrication Using Halftoning To Control Thickness.”

### BACKGROUND

Printers can be used for a wide variety of industrial fabrication processes in which a liquid is printed onto a substrate, and then, is cured, dried, or otherwise processed to convert this “ink” into a finished layer having a specifically intended thickness, and to impart structural, electrical, optical or other properties to a manufactured product. The requirements of some of these fabrication processes can be very precise, for example, calling for positional accuracy of deposited material that is accurate to micron resolution or better. As a single example, a “room-sized” industrial ink jet printer can be used to print droplets of a liquid onto substrate more than a meter long and more than a meter wide, where the process deposits a specific layer of millions of individual “pixels” that will form parts of a high-definition (HD) smart phone display. Each layer fabricated in this manner can have exacting volumetric specification (e.g., “50 picoliters per pixel”), which if not strictly adhered to can cause defects in the finished product. The process can also be used to deposit encapsulation and other macroscale layers that cover many such minute electronic or optical components, where very consistent thickness (and thus control over volume per unit area) is also required. Depending on the particular product being fabricated, fabrication can be performed on a single large substrate to form one or many products; for example, a single, large substrate can be used to make one large electronic display (e.g., a giant HD TV screen) or many smaller products (e.g., “one hundred” smart phone HD displays) which are arrayed and cut from a substrate during manufacturing.

To provide high precision required for many designs, printers and other types of precision fabrication apparatuses are subjected to exacting calibration and alignment procedures designed to ensure that material deposition occurs exactly where intended. As one example, split-axis printers typically feature a “y-axis” transport system that moves a substrate and an “x-axis” transport system that moves a print head (or other assemblies, for example, one or more inspection tools, an ultraviolet lamp used for cure, or other types of things). Typically, these various transport paths are painstakingly and manually calibrated relative to the printer's frame of reference, often based on the subjective interpretation of a human operator; once each substrate is loaded, that substrate must also typically be individually aligned to the printer's positional reference system. Over time, the transport paths and positional reference system must typically be recalibrated and realigned, for example, because of various sources of drift; typically, the fabrication apparatus must be taken off line and physically invaded for this to occur, once again, requiring painstaking, typically highly manual procedures. While the split-axis printer example is an exemplary context only, it illustrates some of the difficulty involved in achieving precision in microstructure product fabrication; the downtime and required manual procedures limit throughput of the product, but are typically necessary, i.e., even if fabrication is “microns off” of intended position, this can translate to an inoperative or low quality finished product.

Depending on application, it can also be quite important to precisely measure and calibrate additional dimensions, such as height of a deposition source above the substrates (e.g., typically the “z-axis”). Fabrication apparatuses of the type described typically are operated to perform deposition as quickly as possible (while preserving accuracy); for a split-axis printer, deposition typically occurs “on-the-fly,” i.e., a print head and substrate are moving relative to one another while ink droplets are ejected, such that height error translates to positional error in the droplets' landing positions. Height error can be more than trivial, e.g., some industrial printing systems can feature a dozen or more print heads which collectively support thousands of nozzles, each producing picoliter-scale droplets that are intended to have very precise landing positions; when it is considered that each print head can have a nozzle ejection plate at a slightly different height, or that is off-level, it can be appreciated that variability in z-axis height of the nozzles can impeded precise control over droplet landing position, e.g., in such systems, a height distance error for each nozzle often directly translates to a droplet landing position error that is twenty percent or more of the height distance for droplets produced from that nozzle.

What are needed are techniques for improving calibration capabilities of manufacturing systems. Ideally, such techniques would facilitate more accurate calibration, and thus promote very high precision in these systems. Ideally still, these techniques could be performed more quickly or even on a fully automated basis, substantially reducing the amount of time and effort needed for calibration. In an industrial printing system, these types of improvements would improve manufacturing system up-time, thereby increasing throughput and lowering overall manufacturing cost. The present invention addresses these needs and provides further, related advantages.

### BRIEF DESCRIPTION OF THE DRAWINGS

FIG. 1A illustrates an assembly-line style production process where a series of substrates 105 will have one or more layers of material deposited thereon by deposition equipment 103 to form a part of precision electrical structures. Note that only one set of deposition equipment 103 is depicted, but in fact, there can be many (e.g., earlier or later in the process, to perform other processing or to deposit other types of materials, structures or films). Each substrate once finished (such as substrate 107) can be used to form a part of one or more electronic products (such as by way of non-limiting example, part of a cell phone 109, HDTV 111, solar panel 113, or another structure).

FIG. 1B is a plan, schematic view of one layout or configuration of deposition equipment, such as might be used as the deposition equipment from FIG. 1A. A printer module 125 is used to deposit a liquid (i.e., “ink”) that, unlike graphics ink, will be processed (e.g., by processing module 127) to form a thin film that will become one of the layers of the precision electrical structures referred to in connection with FIG. 1A.

FIG. 1C is a plan view illustrating the basic operation of a printer 151 within the printing module from FIG. 1B; this printer exemplifies a “split-axis” mechanical system. As depicted, a first transport system (e.g., a “gripper” system 159) transports a substrate 157 in a “y-axis” direction, as indicated by a first double-arrow 161, while a second transport system transports a print head 165 in an “x-axis” direction, as indicated by a second double arrow 169.

FIG. 1D shows an exemplary substrate 181 and its supported fabrication of four electronic products (183), each having many micron-or-smaller-scale electrical, optical, or other structures (not individually seen). The substrate is moved back and forth along its long axis, while a print head 191 is moved (i.e., as indicated by arrow 195) in between such “scans,” so as to print “swaths” of ink over the surface of the exemplary substrate 181.

FIG. 2A illustrates one embodiment of mechanisms and techniques used to provide precise position in a split-axis system, such as a split-axis printer.

FIG. 2B illustrates another embodiment of mechanisms and techniques used to provide precise position in a split-axis system.

FIG. 3A is a flow chart showing techniques for position alignment and calibration in a fabrication apparatus.

FIG. 3B is a flow chart showing techniques for position alignment and calibration in a split-axis printer.

FIG. 4A is a flow chart 401 showing operation of an ink jet printer to deposit materials that will form a layer of an electronic product.

FIG. 4B illustrates one embodiment of mechanical and electromechanical components used to provide improved precision position calibration and alignment in a split-axis system.

FIG. 4C is a flow chart illustrating techniques used in concert with the components depicted in FIG. 4C to provide automatic and/or dynamic position determination in a split-axis fabrication and/or printing system.

FIG. 5A is a perspective view of one embodiment of a gripper system, and supporting table (or chuck) on which a gripper rides.

FIG. 5B is a perspective view of a camera assembly, used in association with a print head assembly.

FIG. 5C is a close-up, perspective view of a reticle used by camera of the assemblies from FIGS. 5A and 5B.

FIG. 5D is a close-up, perspective view of a calibration standard or “gauge block” used for laser-height measurement in one embodiment.

FIG. 5E is a close-up perspective view of an alignment plate or target, which will be mounted to a gripper system or print head assembly.

The subject matter defined by the enumerated claims may be better understood by referring to the following detailed description, which should be read in conjunction with the accompanying drawings. This description of one or more particular embodiments, set out below to enable one to build and use various implementations of the technology set forth by the claims, is not intended to limit the enumerated claims, but to exemplify their application. Without limiting the foregoing, this disclosure provides several different examples of techniques for position determination and for calibration and alignment of position sensing subsystems used for precision manufacture. Such techniques can be employed in the automated fabrication of a thin film for one or more products of a substrate, as part of an integral, repeatable print process. The various techniques can be embodied as software for performing these techniques, in the form of a computer, printer or other device running such software, or a component thereof, in the form of an industrial printing and/or manufacturing system (or component of such a system), as a fabrication apparatus, or in the form of an electronic or other device fabricated as a result of using these techniques (e.g., having one or more layers produced according to the described techniques). While specific examples are presented, the principles described herein may also be applied to other methods, devices and systems as well.

### DETAILED DESCRIPTION

### A. Introduction

This disclosure provides improved techniques calibrating and aligning components of a fabrication apparatus and/or printer, for precise position measurement in such an apparatus or printer in one or more dimensions, and for associated fabrication of one or more layers of an electronic product. More specifically, devices, methods, apparatuses, and systems disclosed herein provide for improved accuracy and speed in calibrating and aligning positional systems in manufacturing systems and/or printers, thereby facilitating micron-scale or better accuracy in the deposition or processing of structures in manufactured products. The techniques disclosed herein provide for far more rapid, highly automated, repeatable calibration and alignment process, thereby reducing system down-time and substantially improving manufacturing throughput. In one embodiment, these techniques provide an improved, highly accurate, dynamic means of measuring precise height of a deposition source above a substrate (e.g., “z-axis” height), thereby further improving positional accuracy in deposited material. By providing such accuracy, the disclosed techniques facilitate smaller, denser, more reliable devices, thereby further enhancing the trend toward smaller, more reliable, full featured electronic products. The disclosed techniques provide further, related advantages as well.

In one embodiment, the disclosed techniques are presented as an improved way of aligning split-axis transport systems. Imaging systems or other sensors mounted to each transport path are aligned with each other (and/or a common frame of reference, such as a manufacturing chuck), and a position feedback system is used for each transport path to provide precise positional accuracy to drive systems, enabling micron or better position discrimination. The disclosed techniques advantageously also optionally facilitate micron or better height determination (e.g., z-axis determination) between a deposition substrate and a source of the deposited material, further enhancing positional accuracy.

In a second embodiment, the disclosed techniques provide an accurate “z-axis” height calibration and/or position determination system, i.e., that can be used without having to manually invade a fabrication apparatus. Such a system optionally uses z-axis sensors above and below a deposition plane to identify a common frame of reference, and to accurately measure absolute position of a deposition source above a substrate. In one implementation, a first sensor above the substrate measures absolute height of the sensor relative to the substrate, while a second such sensor below the substrate is used to measure differences in height between the first sensor and the deposition source (e.g., one or more print heads of a printer). These techniques can be automated and used for a wide variety of purposes, such as adjusting print head level and/or height, and otherwise adjusting printing or system parameters so as to eliminate potential sources of error.

The components of these various techniques can optionally be used in any desired combination or permutation.

Note that in a printing system, particularly one that features interchangeable print heads and/or multiple print heads, height determination can be non-trivial. That is, in a precision manufacturing system, the height between nozzle orifices (e.g., a print head ejection plate) and a substrate surface can vary by tens of microns or potentially more, due to a variety of factors. Because droplet ejection is typically performed using relative motion between the print head(s) and substrate, this variation can lead to errors in droplet landing position by tens of microns or more, detracting from the desired positional accuracy. One notable advantage of some of the techniques provided herein is that, by provided for far more accurate, fast determination of nozzle height relative to substrate surface, this error can be corrected for, enabling far more accurate droplet placement (which facilitates manufacturing advantages, as referenced above). Note that, with an understanding of height and height variation, in such a system, a number of techniques can be used to mitigate error; for example, print heads can be manually or automatically adjusted in height or leveled; in addition, in some embodiments, error can be compensated for in software, e.g., by adjusting pre-planned print parameters such as nozzle timing, droplet velocity, droplet waveform and even which of the many nozzles on a print head are used to print each droplet. Techniques are disclosed herein for mitigating any errors in nozzle position, nozzle height to substrate, substrate positional errors, scale errors, product skew errors (“shear”) and so forth, based on an understanding of height and/or position provided using the described alignment and calibration and height-measurement techniques. The described techniques are particularly useful for industrial fabrication and/or printing applications where it is important to have fine grain positional accuracy at a microscopic level (e.g., to a resolution of ten microns or better), to permit precise feature fabrication and/or deposition of deposited substances.

In one implementation, at least one optical means is used for alignment and calibration of at least two different transport path directions, to provide for micron-or-near-micron resolution x,y positional accuracy relative to a substrate and/or manufacturing chuck; such a means for example can include one or more cameras that produce a high-resolution digital image used to calibrate each transport path to a common reference point. Optionally, a position feedback system (imaging or non-imaging) is also used to permit transport path drive correction in each transport axis direction, so as to provide micron-or-near-micron resolution positional accuracy across each transport path direction (e.g., in a split-axis system, such as an exemplary printing system described below, the two transport paths are optically aligned to an origin point, and a position feedback system is used for each transport path to ensure precise transport path advancement). A second means is then optionally also used for z-axis calibration and position sensing; any positional offset of the second such means relative to the calibrated x,y position is identified, permitting z-height determination at any point relative to the chuck of manufacturing substrate. In one embodiment, because the deposition source might be at a different height (or misaligned) relative to the second means, height can be derived by a suitable processes, for example, by (a) measuring height difference between a first z-axis measurement system which is above the manufacturing surface, (b) using a second z-axis measurement system below the manufacturing surface to measure any height difference between the first z-axis measurement system and the source of deposition material (e.g., a print head or specific print head nozzle), and (c) calibrating the first z-axis height determination system so as to match it or “zero it” to a known coordinate reference system. As implied, this ability, and ability to remeasure height during system operation in a non-invasive manner, can be relied on to provide dynamic height measurement with far reaching effects; for example, as print heads or other manufacturing tools are swapped, deposition source height can be immediately, automatically, and dynamically remeasured, thereby substantially improving system up-time. The fact that these measurements can be automatically tied to a precise coordinate system also reduces error arising from subjectivity of a human operation, thereby provided for far more accurate results.

Precise knowledge of height between the deposition source and the substrate surface can be used to correct deposition location with a fine degree of accuracy. As noted earlier, various error/variation mitigation strategies include changing source (e.g., print head) height, alignment or level, changing substrate height or position, changing source drive signals (e.g., nozzle drive signals) so as to change ejection velocity (i.e., thereby correcting landing location), changing ejection time (i.e., thereby also correcting landing location to offset error), changing which source is used for deposition (e.g., using different nozzles which provide replacement landing position closer to desired position), and/or potentially changing other deposition and/or mechanical parameters, in software or otherwise.

One example of a manufacturing system that can benefit from the described techniques is an industrial fabrication system that relies on an ink jet printer to deposit droplets of a liquid onto a substrate, for example, to deposit organic materials that cannot be easily deposited using other fabrication processes. The droplets, which are ejected from literally thousands of nozzles in parallel (from one of many print heads), land on the substrate and meld together, to form a continuous liquid coat or liquid film. The liquid, however, has a viscous property such that thickness of the coat can locally vary depending on droplet density and/or other forms of volume control (see the incorporated by reference patents and publication, referred to earlier). The film can provide “blanket” liquid coverage of an area that is either large relative to electronic microstructures (e.g., it can provide an encapsulation, barrier, smoothing, dielectric or other layer that spans many such microstructures) or that is contained within a fluidic dam, for example, so as to form a layer of a single pixel or light emitting structure, with the same layer for many such structures being fabricated at the same time. For example, the mentioned manufacturing system can be used to print in one deposition process the same organic light emitting layer for each one of millions of pixels that will form an HDTV; in such a fabrication process, there can be millions of corresponding microscopic wells, and it is typically desired to deposit precise liquid quantities just within these wells. Whatever layer is being fabricated, the continuous liquid coat is, following printing and stabilization, processed to cure, dry, harden, solidify, stabilize, or otherwise process the deposited liquid coat, so as to convert it to a permanent or semi-permanent form (e.g., a processed layer). Given the fine precision needed to deposit precise quantities of ink at a microscopic scale, or otherwise to ensure a homogeneous layer or specific edge profile, the describe alignment, calibration and measurement techniques provide a powerful tool to facilitate very precise droplet placement and, otherwise provide for very fine deposition control. These and other examples will be further discussed below.

Prior to proceeding to the additional discussion, it would be helpful to first introduce certain terms used herein.

Specifically, various references will be made in this disclosure to “ink.” Unlike the colored liquid used in graphics application, which generally is absorbed into a supporting medium and conveys imagery through its color (tone) and brightness, the “ink” generally deposited by printers discussed in this disclosure typically has no significant color or image property in and of itself; instead, the liquid carries a materials that, once deposited and processed, will provide a deliberate layer thickness and a structural component that provides desired structural, optical, electrical and/or other properties. While many materials can be deposited in theory using this process, in several contemplated applications, the “ink” is essentially a liquid monomer which will be converted following deposition into a polymer (i.e., into a plastic having desired conductance, optical, or other properties). In one specific application, where the deposited layer forms a part of an organic light emitting diode (“OLED”) display, the deposited layer can contribute to color and imagery through electromagnetic actuation, but the point is that the liquid itself is not being deposited for the purpose of transferring inherent color of the liquid to a substrate as part of a predefined image, but rather, is being used to build a structure. In a typical application, the liquid is deposited in the form of discrete droplets that spread to a limited extent, meld together, and provide “blanket” coverage (i.e., typically without holes or gaps in coverage) at least within the confines of a fluidic well.

Specifically contemplated implementations can also include an apparatus comprising instructions stored on non-transitory machine-readable media. Such instructional logic can be written or designed in a manner that has certain structure (architectural features) such that, when the instructions are ultimately executed, they cause the one or more general purpose machines (e.g., a processor, computer or other machine) to behave as a special purpose machine, having structure that necessarily performs described tasks on input operands in dependence on the instructions to take specific actions or otherwise produce specific outputs. For example, the techniques described herein can be embodied as control software stored on non-transitory machine-readable media that, when executed, cause one or more processors and/or other equipment to perform the calibration, alignment, and position determination functions described herein. “Non-transitory” machine-readable or processor-accessible “media” or “storage” as used herein means any tangible (i.e., physical) storage medium, irrespective of the technology used to store data on that medium, e.g., including without limitation, random access memory, hard disk memory, optical memory, a floppy disk or CD, server storage, volatile memory, non-volatile memory, in-computer memory, detachable storage, and other tangible mechanisms where instructions may subsequently be retrieved by a machine. The media or storage can be in standalone form (e.g., a program disk or solid state device) or embodied as part of a larger mechanism, for example, a laptop computer, portable device, server, network, printer, or other set of one or more devices. The instructions can be implemented in different formats, for example, as metadata that when called is effective to invoke a certain action, as Java code or scripting, as code written in a specific programming language (e.g., as C++ code), as a processor-specific instruction set, or in some other form; the instructions can also be executed by the same processor or different processors or processor cores, depending on embodiment. Throughout this disclosure, various processes will be described, any of which can generally be implemented as instructions stored on non-transitory machine-readable media, and any of which can be used to fabricate products. Depending on product design, such products can be fabricated to be in saleable form, or as a preparatory step for other printing, curing, manufacturing or other processing steps, that will ultimately create finished products for sale, distribution, exportation or importation where those products incorporate the fabricated layer. Again to cite an example, it has already been mentioned that one contemplated implementation is used to manufacture a layer of electronic displays—other layers can be optionally added via other processes without detracting from (or substantially altering) a layer fabricated according to the precision processes described herein; a resulting display can also be combined with other components (e.g., so as to form a working television or other electronic device) without substantially altering a layer fabricated according to the precision processes described herein. Also, depending on implementation, instructions or methods described herein can be executed by a single computer and, in other cases, can be stored and/or executed on a distributed basis, e.g., using one or more servers, web clients, or application-specific devices. Each function mentioned in reference to the various FIGS. herein can be implemented as part of a combined program or as a standalone module, either stored together on a single media expression (e.g., single floppy disk) or on multiple, separate storage devices. The same is also true for error correction information generated according to the processes described herein, i.e., a template or “recipe” representing predetermined printing can be modified to incorporate position error or feedback and stored on non-transitory machine-readable media for current or later use, either on the same machine or for use on one or more other machines; for example, such data can be generated using a first machine, and then stored for transfer to a printer or manufacturing device, e.g., for download via the internet (or another network) or for manual transport (e.g., via a transport media such as a portable drive) for use on another machine. A “raster” or “scan path” as used herein refers to a progression of motion of a print head or camera relative to a substrate, i.e., it need not be linear or continuous in all embodiments. “Hardening,” “solidifying,” “processing” and/or “rendering” of a layer as that term is used herein refers to processes applied to deposited ink to convert that ink from a liquid form to a permanent or semi-permanent structure of the thing being made (e.g., as contrasted with a transitory structure such as a temporary mask). Throughout this disclosure, various processes will be described, any of which can generally be implemented as instructional logic (e.g., as instructions stored on non-transitory machine-readable media or other software logic), as hardware logic, or as a combination of these things, depending on embodiment or specific design. “Module” as used herein refers to a structure dedicated to a specific function; for example, a “first module” to perform a first specific function and a “second module” to perform a second specific function, when used in the context of instructions (e.g., computer code) refer to mutually-exclusive code sets. When used in the context of mechanical or electromechanical structures (e.g., an “encryption module”), the term module refers to a dedicated set of components which might include hardware and/or software. In all cases, the term “module” is used to refer to a specific structure for performing a function or operation that would be understood by one of ordinary skill in the art to which the subject matter pertains as a conventional structure used in the specific art (e.g., a software module or hardware module), and not as a generic placeholder or “means” for “any structure whatsoever” (e.g., “a team of oxen”) for performing a recited function.

Also, reference is made herein to a detection mechanism and to alignment marks or fiducials that are recognized on each substrate or as part of a printer platen or transport path or as part of a print head. In many embodiments, the detection mechanism is an optical detection mechanism that uses a sensor array (e.g., a camera) to detect recognizable shapes or patterns on a substrate (and/or on a physical structure within the printer). Other embodiments are not predicated on a sensor “array,” for example, a line sensor, can be used to sense fiducials as a substrate is loaded into or advanced within the printer. Note that some embodiments rely on patterns (e.g., simple alignment guides, lines or marks) while others rely on more complex, recognizable features (including geometry of any previously deposited layers on a substrate or physical features in a printer or print head), each of these being a “fiducial.” In addition to using visible light, other embodiments can rely on ultraviolet or other nonvisible light, magnetic, radio frequency or other forms of detection of substrate particulars relative to expected printing position. Also note that various embodiments herein will refer to a print head, print heads or a print head assembly, but it should be understood that the printing systems described herein can generally be used with one or more print heads, whether mounted in modular form or otherwise; in one contemplated application, for example, an industrial printer features three print head assemblies (each sometimes called an “ink stick” mount), each such assembly or mount having three separate print heads with mechanical mounting systems that permit positional and/or rotational adjustment, such that constituent print heads (e.g., of a print head assembly) and/or print head assemblies and/or their nozzles can be aligned with precision to a desired grid system; other configurations with one or more print heads are also possible. Generally speaking, a “film” or “coat” is used herein to refer to raw deposition material (e.g., a liquid) whereas a “layer” will generally be used to refer to a post-processing structure, for example, to something that has been converted into a solidified, hardened, polymerized, or other permanent or semi-permanent form. Generally speaking, the “x-axis” and “y-axis” will be used to refer to a plane of deposition, while the “z-axis” will refer to a direction normal to that plane, but it should be understood that these references can refer to any respective degrees of motion freedom. Various other terms will be defined below, or used in a manner in a manner apparent from context.

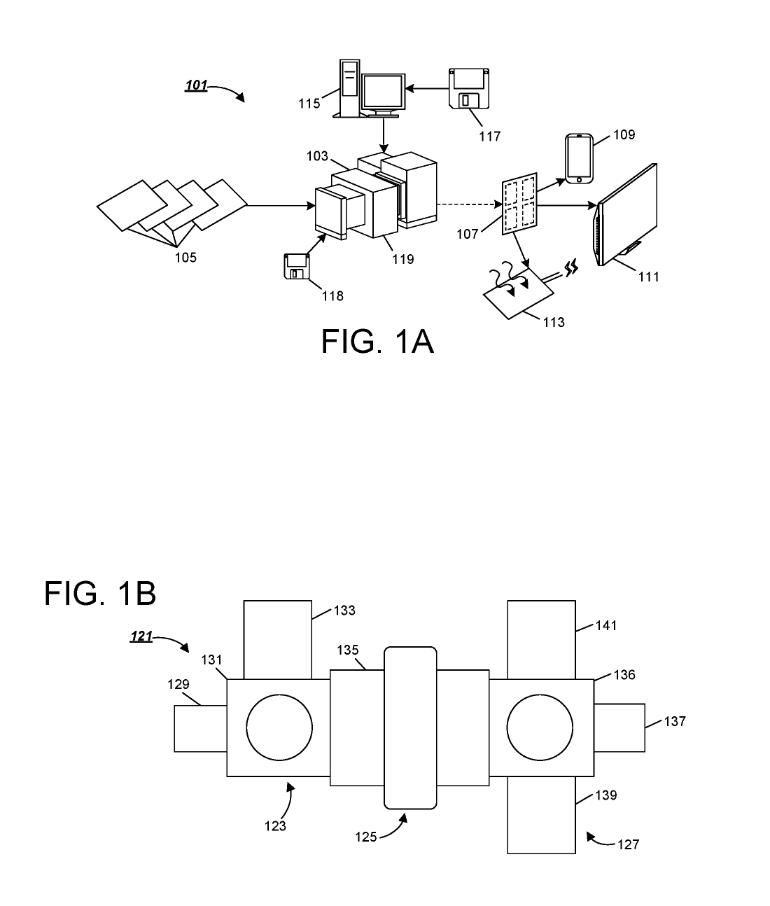

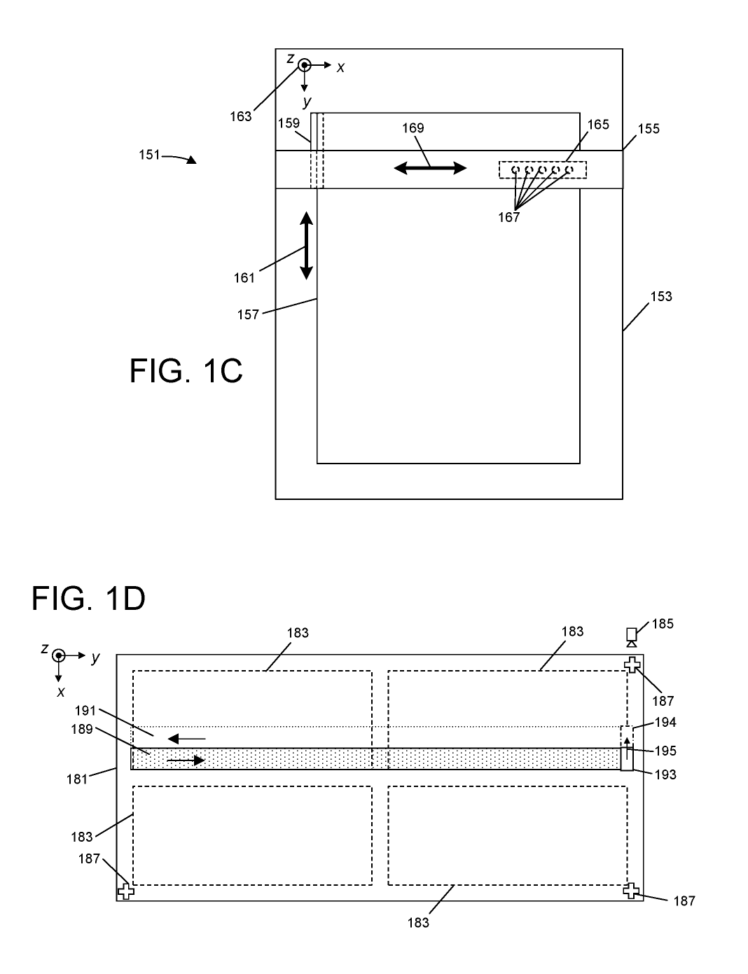

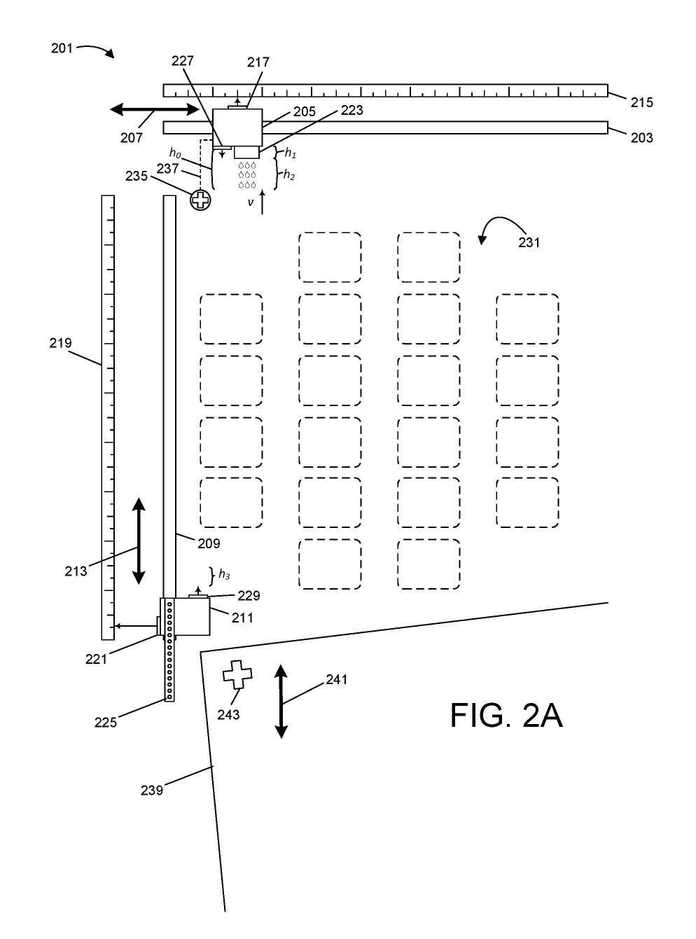

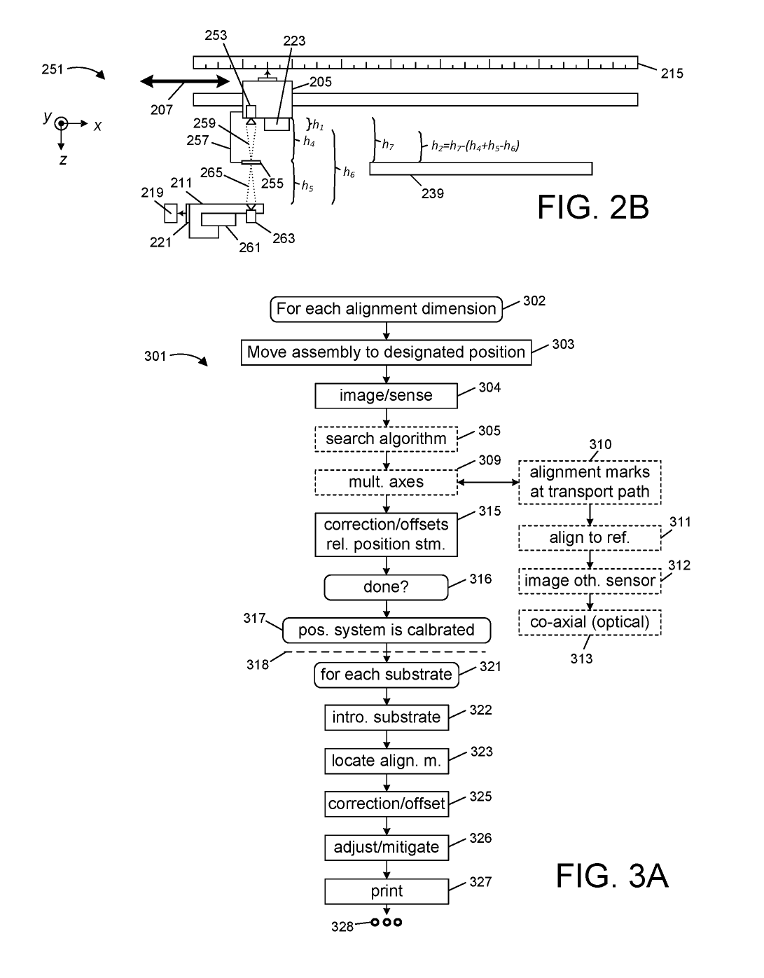

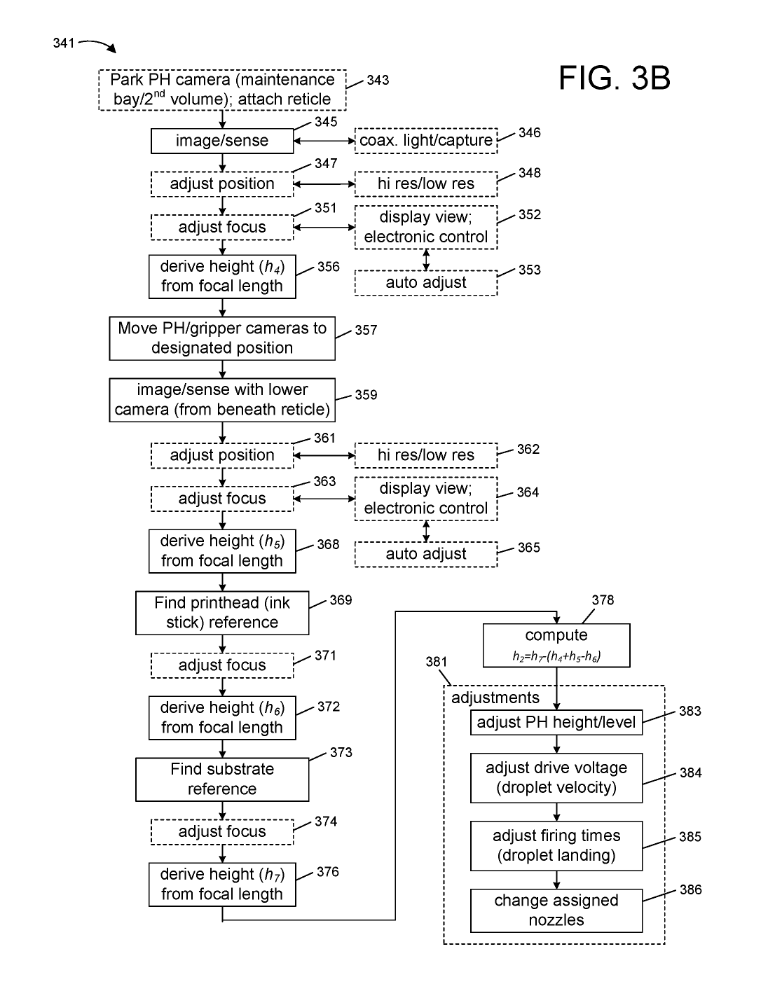

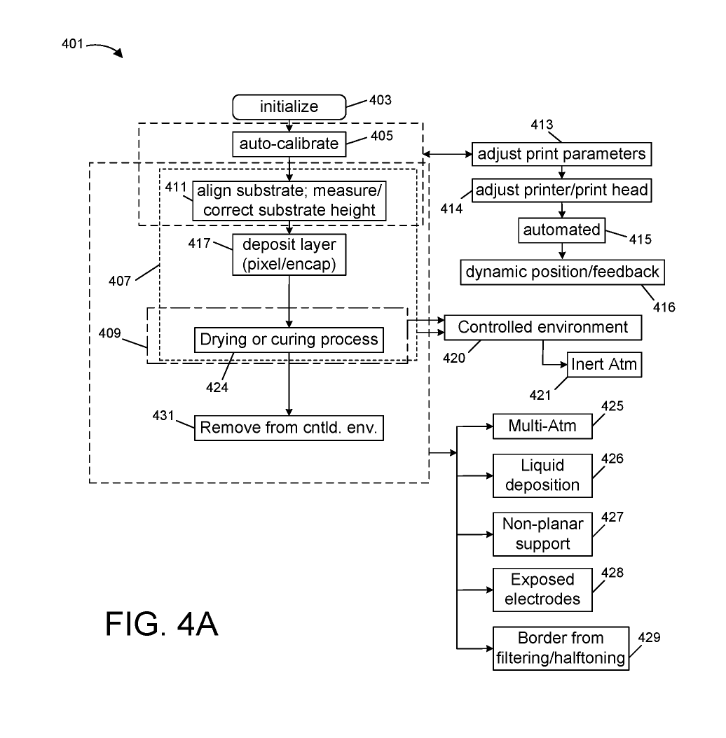

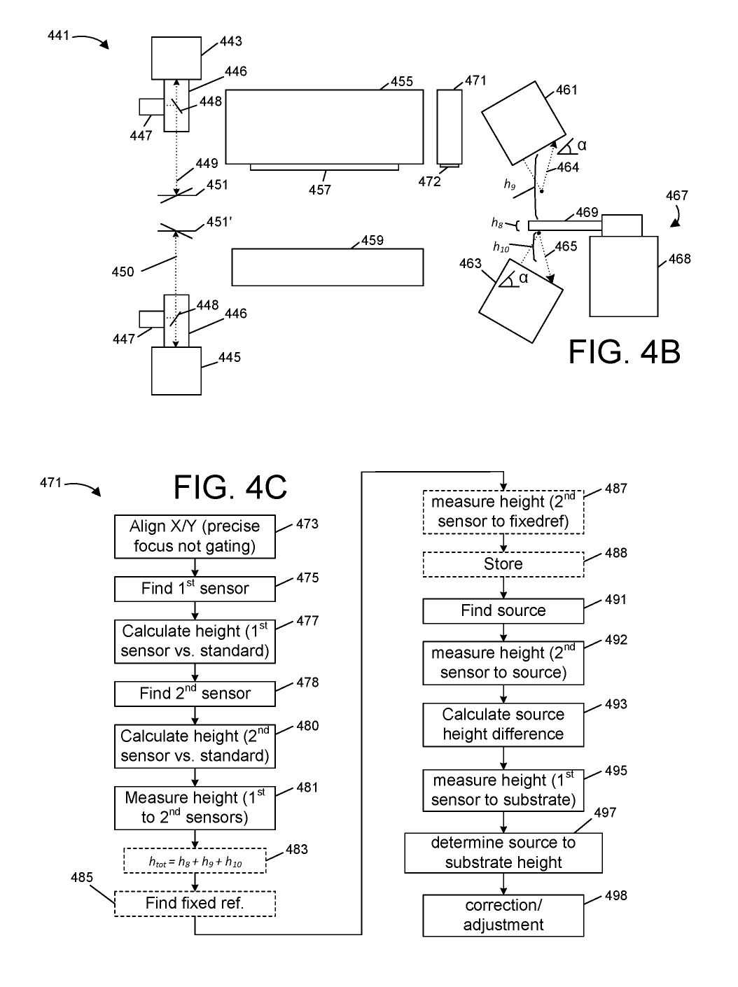

In the discussion that follows, the basic configuration of a split-axis industrial printer will first be explained, with reference to FIGS. 1A-1D, followed by a discussion of some of the challenges relating to precise droplet placement and how novel structures used by such a split-axis industrial printer address these challenges. FIGS. 2A-2B will be discussed as showing structure for first and second embodiments, while FIGS. 3A-3B will be discussed as showing exemplary steps or methods of operation of these embodiments, respectively. Generally speaking, embodiments will first be described that perform x,y positional calibration and alignment, with z-axis measurement then additionally described on an incremental basis. FIGS. 4A-4C will be used to describe an embodiment that provides for high-resolution measurement of absolute z-axis (i.e., height) measurement, and associated alignment with a fabrication apparatus coordinate system. The ensuing FIGS. will then be used to describe yet additional, more detailed embodiments. Such designs can be embodied in a printing system designed to deposit organic materials used to fabricate layers of light emitting products, e.g., including “active” layers that contribute to the generation of light, as well as passive layers that encapsulate sensitive electronic components; for example such a fabrication apparatus can be used in the fabrication of “OLED” television and other display screens.

### B. An Exemplary Context—A Split-Axis System that Includes a Printer

FIG. 1A provides an overview of a manufacturing process, collectively designated by reference numeral 101; this FIG. also represents a number of possible discrete implementations of the techniques introduced herein. As seen at the left-hand side of the FIG., a series of substrates 105 is to be processed, with each substrate having a layer deposited thereon where the deposition process is aided by the techniques described herein, such that the process becomes more accurate and/or faster for the series than would be the case without these techniques. The right-hand side of FIG. 1A shows one of the substrates in the series, 107, now in finished form, where it is ready to be cut into a number of products (as represented by dashed line portions of the substrate 107), for example, the finished substrate 107 can be used to form one or more cell phone displays 109, HDTV displays 111, or solar panels 113.

To form the layer in question, a fabrication apparatus 103 is used to deposit, fabricate and/or process a material. As will be further discussed below, in one embodiment, the fabrication apparatus can include a printer (119) that will print the material in the form of discrete droplets of a liquid, where the droplets spread to a limited extent to form a continuous liquid coat (at least locally) and where the fabrication apparatus or another device then processes that liquid coat to convert the material to a form that is permanent or semi-permanent. In one example, the liquid is an organic material (e.g., a monomer) that is cured, dried, baked or otherwise processed, to change the form and/or physical properties of the organic material to a form in which it will persist as the layer of the finished device; one contemplated manufacturing process can use an ultraviolet (“UV”) lamp to convert the monomer to a polymer, essentially converting it to a conductive, electrically-active, light-emitting, or other form of plastic. The techniques described herein are not limited to these types of materials. Also, note that there can be prior processing steps (e.g., there may be an extant, underlying surface geometry composed of microstructures already on the substrates 105) and/or subsequent processing steps (e.g., other layers and/or processing can be applied after finishing of the layer and/or film produced by fabrication apparatus 103. FIG. 1A also shows a first computer icon 115 and associated non-transitory machine-readable media icon 117, to denote that the fabrication apparatus can be controlled by one or more processors acting under the control of instruction logic; for example, such software and/or processors can control or command the calibration, alignment and measurement techniques described herein. FIG. 1A also shows a second non-transitory machine-readable media icon 118, representing that the deposition onto each substrate 105 in the series can be performed according to instructions for a predefined print process or “recipe,” e.g., a common design that is intended to be applied to each substrate 105 in the series. The techniques described herein can be used to adjust printer components and/or print process parameters, so as to more accurately print according to a common recipe, or it can be used to transform or adjust the recipe itself (e.g., potentially, substrate by substrate) such that individual printing actions (e.g., such as firing signals applied to nozzles) are adjusted in dependence on the calibration, alignment, and measurement described herein; the latter process effectively adjusts the design so as to mitigate error/variation and produce the desired printing result notwithstanding such error or variation.

Thus, techniques introduced in this disclosure can optionally take the form of instructions stored on non-transitory machine-readable media 117, e.g., control software. Per computer icon 115, these techniques can also optionally be implemented as part of a computer or network, for example, as part of a computer system used by a company that manufactures products. Third, as exemplified using numeral 103, the techniques introduced earlier can take the form of a fabrication apparatus or component thereof, e.g., a position measurement system for a fabrication apparatus, or a printer that is controlled according to position signals and/or calibration generated using the techniques described herein. Fourth, the techniques described herein can take the form of a modified “recipe” (e.g., printer control instructions modified to mitigate alignment, scale, skew or other error). Finally, the techniques introduced above can also be embodied as the product or thing itself being manufactures; in FIG. 1A for example, several such components are depicted in the form of an array 107 of semi-finished flat panel devices, that will be separated and sold for incorporation into end consumer products. The depicted devices may have, for example, one or more light generating layers or encapsulation layers or other layers fabricated in dependence on the methods introduced above. For example, the techniques described herein can be embodied in the form of improved digital devices 109/111/113 (e.g., such as electronic pads or cell phones, television display screens, solar panels), or other types of devices.

FIG. 1B shows one contemplated multi-chambered fabrication apparatus 121 that can be used to apply techniques disclosed herein. Generally speaking, the depicted apparatus 121 includes several general modules or subsystems including a transfer module 123, a printing module 125 and a processing module 127. Each module in this example, maintains a controlled environment against ambient air. The controlled environment can be the same throughout fabrication apparatus 121 or can differ for each chamber. The transfer module 123 is used to load and unload substrates, or otherwise exchange them with other fabrication apparatuses. Each received substrate can be printed upon by the printing module 125 in a first controlled atmosphere and (if desired) other processing, for example, another deposition process or curing, drying or baking process (e.g., for printed materials), can be performed by a processing module 127 in the first or a second controlled atmosphere. The fabrication apparatus 121 uses one or more mechanical handlers to move a substrate between modules without exposing the substrate to an uncontrolled atmosphere (that is, to ambient air, which may contain contaminants such as particulate, moisture and so forth). Within any given module, it is possible to use other substrate handling systems and/or specific devices and control systems adapted to the processing to be performed for that module. Within the printing module 125, mechanical handling can include use (within a controlled atmosphere) of a flotation table, gripper, and alignment/fine error correction mechanisms, such as discussed above and below. Other types of deposition apparatuses (besides printers) can be used in some embodiments.

Various embodiments of the transfer module 123 can include an input loadlock 129 (i.e., a chamber that provides buffering between different environments while maintaining a controlled atmosphere), a transfer chamber 131 (also having a handler for transporting a substrate), and an atmospheric buffer chamber 133. Within the printing module 125, as noted, a flotation table can be used for stable support of a substrate during printing. Additionally, a xyz-motion system, such as a split-axis or gantry motion system, can be used for precise positioning of at least one print head relative to the substrate, as well as providing motorized y-axis transport of the substrate through the printing module 125 and motorized x-axis and z-axis conveyance of one or more print heads. It is also possible within the printing chamber to use multiple inks for printing, e.g., using respective print heads or print head assemblies such that, for example, two different types of deposition processes can be performed within the printing module in a controlled atmosphere. The printing module 125 can comprise a gas enclosure 135 housing an inkjet printing system, with means for introducing an inert atmosphere (e.g., nitrogen or a Noble gas) and otherwise controlling the atmosphere for environmental regulation (e.g., temperature and pressure), gas constituency and particulate presence.

Various embodiments of the processing module 127 can include, for example, a transfer chamber 136; this transfer chamber also has a handler for transporting a substrate. In addition, the processing module can also include an output loadlock 137 for exchanging a substrate with another fabrication apparatus or otherwise unloading a substrate, a nitrogen stack buffer 139, and a curing chamber 141. In some applications, the curing chamber can be used to cure a monomer film to convert it to a uniform polymer film; in other applications, the curing chamber can be replaced with a drying oven or other processing chamber. For example, two specifically contemplated processes include a heating process and a UV radiation cure process.

In one application, the apparatus 121 is adapted for bulk production of liquid crystal display screens or OLED display screens, for example, the fabrication of an array of (e.g.) eight screens at once on a single large substrate. These screens can be used for televisions and as display screens for other forms of electronic devices. In a second application, the apparatus can be used for bulk production of solar panels or other electronic devices in much the same manner. In an exemplary assembly-line style process, each substrate in a series of substrates is fed in through the input loadlock 129, is mechanically advanced into transfer chamber 131. As suited, the substrate is then transferred to the printing module where a liquid coat is deposited according to very precise positional parameters, in the manner already introduced. Following a settling time, which permits droplets to meld and establish a locally-uniform liquid coat, the substrate is advanced into the processing module 127, where it is variously transferred to a suitable chamber (e.g., curing chamber 141) for the appropriate cure or other processes to finish the layer, and the layer is then transferred out through output loadlock 137. Note that various ones of these modules may be swapped, omitted or varied depending on configuration, i.e., whatever the process, the fabrication apparatus at a minimum deposits some material that will be used to “build” the desired layer of the finished product. As noted earlier, in a conventional process, deposition parameters may be exacting, requiring that each “picoliter-scale” droplet be placed at a specific position on the substrate, accurate to one or a few microns, sometimes deliberately varying droplet sizes and/or placement for specifically-desired ends; see the aforementioned patents and patent application which have been incorporated by reference.

By repeated deposition of subsequent layers, each of controlled thickness, light-emitting layers of a light-generating structure, electronic microstructure component layers, or blanket layers (e.g., encapsulation) can be built up to suit any desired application. In one embodiment, one or more of the layers can be different, but it is also possible to fabricate a series of microlayers (e.g., each less than 20 microns thick) to build up an aggregate, thicker layer. The modular format of the depicted fabrication apparatus can be used to customize the fabrication apparatus to a variety of different applications—for example, as noted, one application might use a baking chamber because a “printed” liquid coat is to be processed by baking that layer to render it into a permanent or semi-permanent structure. In a different embodiment, it may be desired to use UV light to cure a deposited layer, and perform similar processing. As should be apparent, therefore, the configuration of the apparatus 121 can be varied to place the various modules 123, 125 and 127 in different juxtaposition, or to use additional, fewer or different modules, much of which will depend on type and design of the manufactured product, desired deposition materials, the particular type of layer to be formed, end-product application, and potentially other factors. As each substrate in the series is finished, a next substrate in the series of substrates is then introduced and processed in much the same manner.

While FIG. 1B provides one example of a set of linked chambers or fabrication components, clearly many other possibilities exist. The techniques introduced above can be used with the device depicted in FIG. 1B, or indeed, to control a fabrication process performed by any other type of deposition equipment.

FIG. 1C shows an overhead schematic view of a split-axis printer 151. This printer can be used as one, non-limiting example of a fabrication apparatus. It is noted that this FIG. is drawn out of scale, using generic parts representations, so as to aid discussion of basic mechanisms and concepts; for example, a print head 165 will typically have many more than the five-depicted nozzles 167, potentially having thousands-to-tens-of-thousands of nozzles, so as to print as wide a swath as practical on an underlying substrate 157, as accurately and quickly as possible. Similarly, only general detail and components are presented in order to illustrate principles of operation. In the context of assembly line-style fabrication, it is generally desired that printing be accomplished for a panel potentially meters long by meters wide in less than 60-90 seconds, i.e., such that the price point of the production process is as low as possible without sacrificing print quality.

The printer includes a print head assembly 165 that is used to deposit ink onto a substrate 157. As mentioned earlier, in a manufacturing process, the ink typically has a viscous property such that it spreads only to a limited extent, retaining a thickness that will translate to layer thickness once any processing is performed to convert the liquid coat to a permanent or semi-permanent structure. The thickness of the layer produced by deposition of liquid ink is dependent on the volume of applied ink, e.g., the density of droplets and/or the volume of droplets deposited at predetermined positions. The ink typically features one or more materials that will form part of the finished layer, formed as monomer, polymer, or a material carried by a solvent or other transport medium. In one embodiment, these materials are organic. Following deposition of the ink, the ink is dried, cured, hardened or otherwise processed to form the permanent or semi-permanent layer; for example, some applications use an ultraviolet (UV) cure process to convert a liquid monomer into a solid polymer, while other processes dry the ink to remove the solvent and leave the transported materials in a desired location. Other processes are also possible. Note that there are many other features that differentiate the depicted printing process from conventional graphics and text applications; for example, as described elsewhere herein, one implementation uses a fabrication apparatus that encloses the printer 151 within a gas chamber, such that printing can be performed in the presence of a controlled atmosphere so as to exclude moisture and other undesired particulate.

As further seen in FIG. 1C, the print head 165 rides back and forth in an “x-axis” dimension on a supporting bar or guide 155 relative to a support table or chuck 153, in the manner generally indicated by double arrows 169. A dimensional legend 163 is placed in the FIG. to assist with axis interpretation. Note also that the print head 165 in this figure is depicted in dashed lines, to indicate that it is concealed by support bar 155, i.e., it faces downward toward the substrate 157 to eject ink droplets that gravitationally fall from respective nozzles 167 and land in a predictable, planned location on a top surface of the substrate 157. Although only a single print head 165 and a single row of nozzles 167 is illustrated in the FIG., it should be appreciated that typically there are multiple print heads each having several hundred nozzles, or several thousand nozzles total; the print heads are usually staggered relative to their “x-axis” position so as to provide an effective pitch between nozzles on the order of tens of microns, with the print heads in some embodiments being mounted to a motion assembly that permits one or more of (a) powered print head rotation, to vary effective “cross-scan” pitch, (b) powered print head height adjustment above the substrate (or better stated, relative to a supporting print head carriage or “ink stick” mounts for a cluster print heads), (c) powered or manual print head leveling, i.e., such that a nozzle orifice plate is parallel to received substrates, and/or (d) modular interchange with other print heads or “ink stick” mounts, and potentially other actions. Note that unlike a typical graphics printer, in which the substrate (e.g., paper) is advanced slowly along the “y-axis” as the print head(s) is(are) moved back and forth as indicated by numeral 169, in an industrial printer, the transport for the substrate along the “y-axis” is typically the fast axis of movement while the print head(s) are usually changed in position only in between scans (relative motion between the substrate and print head), in the direction indicated by double arrow 161; thus, in this example, the “y-axis” is said to be the fast axis or the “in-scan” dimension, while the “x-axis” is said to be the “slow axis” or the “cross-scan” dimension. In this example, each print head present at any one time usually deposits the same ink (even though there may be multiple print heads), with the simultaneous purposes of providing microscopic cross-scan pitch of deposited droplets and covering as wide a swath as practical at once, so as to enable a reduced number of scans and a faster manufacturing/printing speed for each product layer. The substrate is typically a super-thin sheet of glass, and the support table or chuck 153 is typically a flotation table that supports each substrate on a cushion of air (or other atmospheric gas); in the depicted system a vacuum gripper 159 engages the substrate along one edge as it is introduced and moves the substrate back and forth along the y-axis during printing. The gripper rides along a track or path (not illustrated in FIG. 1C) and provides one axis of transport in the depicted split-axis system, while the bar or guide 155 provides another. As should be apparent from this example, any desired printing location on the substrate 157 is obtained by moving the substrate along the y-axis in the in-scan dimension using the gripper 159, and also moving the print head(s) 165 in the cross-scan dimension (i.e., along the x-axis), with each motion being carefully controlled.

As should also be apparent given that the cross-scan nozzle pitch is micron-scale, even slight calibration errors could in theory result in ink droplets being placed in the wrong location on the substrate. Therefore, for precision control of droplet placement in such a system, the calibration techniques described herein are used to ensure that droplets are placed exactly where they are supposed to, i.e., with error of no more than a few microns and ideally much less. As with many of the other descriptions herein, this type of system (printer/split-axis) is representative only, and the specifics just described should be considered optional implementation detail presented so as to understand one possible implementation.

FIG. 1D depicts a single substrate 181 in the series as the substrate moves through the printer, with a number of dashed-line boxes representing individual panel products, 183, as might be the case with a particular design; the FIG. in this example depicts exactly four such panel products. Each substrate (in the series of substrates), such as the substrate 181 appearing in FIG. 1D, in one embodiment has a number of alignment marks 187. In the depicted embodiment, three (or more) such marks 187 are used for the substrate as a whole, enabling measurement of substrate positional offset and/or rotation error relative to the fabrication apparatus (e.g., relative to the chuck, the split-axis transport path, or another frame of reference). Other errors, such as skew error (e.g., the product footprint possesses non-rectilinear primary axes relative to printer axes) and/or scale errors between the substrate and the print image (i.e., in the x-dimension, the y-dimension, or both), can also be detected. One or more camera assemblies 185 are used to image the alignment marks in order to detect these various errors. In one contemplated embodiment, a single camera assembly is used (e.g., mounted to the print head assembly); as mentioned, the split-axis system permits placement of the print head(s) above any location on the substrate through concerted actuation of the two transport systems, and camera assembly articulation in this embodiment is no different, i.e., the transport mechanisms of the printer (e.g., a handler and/or air flotation mechanism) move the substrate and camera to position each alignment mark in sequence in the field of view of the camera assembly; in one embodiment, the assembly includes both a high resolution camera and a low resolution camera, while in a different embodiment, a single camera or a different type of sensor (such as a motionless, optical line sensor) can be used to detect actual position the substrate relative to the printer's reference system. The camera assembly in this example, as implied, can be mounted to the print head carriage or assembly of the print head or a second assembly, or can be mounted to a different carriage (or bridge or guide), depending on embodiment. In the two camera system, low and high magnification images are taken, the low magnification image to coarsely position a fiducial for high resolution magnification, and the high magnification image to identify precise fiducial position according to a printer coordinate system. These various structures are used, relative to FIG. 1D, to detect the relationship between each individual substrate and the coordinate system of the fabrication system, such that substrate alignment, orientation, position, skew and scale can be normalized and factored into deposition, such that ensuing fabrication deposits material in exactly the same location for each substrate (i.e., relative to the alignment marks).

Reflecting on the structures just discussed, in one contemplated embodiment, a camera assembly can be made integral with the print head assembly (i.e., the print head carriage referred to above), so as to both calibrate the positional reference system of the fabrication apparatus (i.e., positional calibration and effective alignment of the two transport paths, prior to introduction of a substrate) and then, as referenced in connection with FIG. 1D, to detect location of each individual substrates fiducials, so as to align each substrate with the printer coordinate system or adjust printing parameters so as to align with each substrate's actual position/orientation/skew and/or scale. As with other described components, the camera assembly may also be a modular unit which is interchangeable with other modules in a maintenance station of the printer, much as with the ink stick mounts referred to above; in one embodiment, however, a camera used by the print head transport path is made an integral, permanent part of the print head assembly.

In a typical implementation, printing will be performed to deposit a given material layer on the entire substrate at once (i.e., with a single print process providing a layer in each scan or set of scans for a substrate for multiple products). Note that such a deposition can be performed within individual pixel wells (not illustrated in FIG. 1D, i.e., there would typically be millions of such wells) to deposit light generating layers within such wells, or on a “blanket” basis to deposit a barrier or protective layer, such as a barrier layer or encapsulation layer. Whichever deposition process is at issue, FIG. 1D shows two illustrative scans 189 and 191 of a print head along the long axis of the substrate; in a split-axis printer, the substrate is typically moved back and forth (e.g., in the direction of the depicted arrows in FIG. 1D and double arrow 161 from FIG. 1C) with the printer advancing the print head(s) positionally (i.e., in the “x-axis” direction or the vertical direction relative to the drawing page) in between scans. Note that while the scan paths are depicted as linear, this is not required in any embodiment. Also, while the scan paths (e.g., 189 and 191) are illustrated as adjacent and mutually-exclusive in terms of covered area, this also is not required in any embodiment (e.g., the print head(s) can be applied on a fractional basis relative to a print swath, as necessary). Finally, also note that any given scan path typically passes over the entire printable length of the substrate to print a layer for (potentially) multiple products in a single pass. Each pass uses nozzle firing decisions according to a “print image” or nozzle bit map, with the aim being to ensure that each droplet in each scan is deposited precisely where it should be relative to substrate and/or product/panel boundaries. As indicated, during a first scan 189 in which the substrate 181 is moved relative to the printer along the “fast-axis” or “in-scan” direction (i.e., the y-axis from FIG. 1C), the print head assembly is placed at a first position 193, while during a second scan 191 in which the substrate is moved in the reverse direction along the “fast-axis” or “in-scan” direction, the print head assembly is repositioned (as indicated by arrow 195) along the “slow-axis” or “cross-scan” direction to instead be at position 194, and thereby effectuate the swath represented by numeral 191.

Once all printing is finished for the layer or film in question, the substrate and wet ink (i.e., deposited liquid, which settles to a liquid coat) can then be transported for curing or processing of the deposited liquid into a permanent or semi-permanent layer. For example, returning briefly to the discussion of FIG. 1B, a substrate can have “ink” applied in a printing module 125, and then be transported to a curing chamber 141, all without breaking the controlled atmosphere until the processed layer has been formed (i.e., this process is advantageously used to inhibit moisture, oxygen or particulate contamination). In a different embodiment, a UV scanner or other processing mechanism can be used in situ, for example, being used on split-axis traveler, in much the same manner as the aforementioned print head/camera assembly (assemblies).

### C. A First Embodiment—Calibration, Alignment and Position Sensing in a Split-Axis System

FIG. 2A is an illustrative view of a split-axis system 201 that utilizes precision calibration, alignment and/or sensing as introduced previously. It is noted that actual implementation may be slightly different than as depicted (for example, a print head 223 typically faces “downward,” into the drawing page, to ejected droplets toward the drawing page instead of as drawn; also, the depicted heights are into and out of the drawing page, rather than as illustrated, and sensor 229 faces upward, out of the drawing page); nevertheless, the depicted illustrations are relied on in this FIG. in order to aid explanation and the reader's understanding.

The split-axis system features a first transport path 203 (e.g., used for transport of a print head assembly 205 in the direction indicated by double arrow 207) and a second transport path 209 (e.g., used for transport of a gripper 211 in the direction indicated by double arrow 213). Note that the double arrows 207 and 213 represent reciprocal motion (e.g., reversal of scan path direction, as represented by reciprocal swaths 189 and 191 from FIG. 1D), and that systems of these type typically feature substantial translational inertia as their components are moved. For this reason and others, a position feedback system is also used for each transport path, as represented by numerals 215 and 219. That is, a bridge or guide used to support the print head assembly features position marks to aid with precise position determination; these marks are typically in the form of an adhesive tape with marks spaced every micron or few microns (i.e., as denoted by “ruler” markings 215). A sensor 217 on the print head assembly 205 images, optically detects or otherwise senses these marks and provides feedback based on actual print head assembly position, which permits an electronic control or drive system (not depicted in FIG. 2A) to precisely position the print head carriage notwithstanding the effects of inertia, jitter or other sources of error. Similarly, the second transport path (e.g., a guide provided by a printer support table or chuck 231) typically also mounts a similar set of position marks such as a marked adhesive tape 219, once again denoted by ruler markings to represent that these marks provide position information; these marks are similarly imaged and/or detected or sensed by a sensor 221 on the gripper 211, and similarly, this feedback system permits an electronic control or drive system (not shown in FIG. 2A) to precisely position the gripper, notwithstanding translational inertia, jitter and other potential sources of error affecting it.

A challenge exists in such a system in terms of linking or aligning these two paths and their associated systems; that is, the first and second transport paths need to be related to each other such that, for example, a coordinate system can be defined and directly associated with printable locations.

To this end, a fiducial of some type capable of being reached and detected by each of the print head assembly 205 and the gripper 211 is provided. This fiducial is depicted by numeral 235 in the FIG. A first sensor 227 associated with the first transport path and a second sensor 229 associated with the second transport path are each used to find this fiducial to establish a coordinate point common to each transport path. The position of each position feedback system for each transport path (e.g., represented by alignment tape or “ruler” depictions 215 and 219) can then be relied upon to position a print head 223 at any specific coordinate location relative to the printable area of the printer. Note once again that FIG. 2A is drawn for ease of illustration and understanding, i.e., the print head 223 and sensor 227 typically face downward, into the drawing page, so as to image the fiducial 235, while by contrast, sensor 229 typically faces upward, out of the drawing page, so as to this fiducial 235 from beneath. To this effect, the gripper 211 can only move in this embodiment in the vertical (“y-axis”) direction, whereas the print head assembly 205 only moves in the horizontal direction; to permit ready location and identification of the fiducial 235, it therefore in one embodiment is directly attached to one of the gripper 211 or the print head assembly 205, i.e., so that it is in a known position relative to one of sensor 227 or sensor 229. In this case, as depicted by dashed line 237, the fiducial 235 is coupled to the print head assembly 205. For example, as will be discussed in embodiments below, it can take the form of an optical reticle, with sensors 227 and 229 each being a camera. In such a system, the carriage or assembly moved by each transport path is adjusted until superimposed images of each transport path feature coincidence of the reticle, and the position feedback system is then used to normalize position of each transport path; such position identification identifies the common coordinate point (e.g., the “origin” of the coordinate system), with the x,y transport system being calibrated to this origin point, such that position feedback provides units of advancement relative to this origin point. The reticle can be an optical attachment that is then optionally removed following this calibration. Note that there exist many alternatives for finding the common reference point (e.g., for example, sensors 227 and 229 could be configured as cooperating elements of a sensing system that permit precise alignment between them, and as this statement implies, many different types of sensors and/or positioning methodologies can be used to perform this colocation). Through the described colocation, a complete x,y coordinate reference system for the printer/fabrication apparatus can be established.

When printing is to start, a substrate 239 is introduced into the system 201 and is engaged by a vacuum element 225 of the gripper 211. As depicted in the FIG., the substrate 239 can have unintended translational offset and/or rotational error and potentially other errors, such as skew and/or scale error; it is therefore generally desired to correct this error or at least account for it so that droplets from the print head(s) can be positioned in exactly the intended positions relative to the substrate and/or any product being fabricated thereon. Note that there exist many mechanisms for correcting this error. For example, it is possible to use a mechanical handler to reposition the substrate; alternatively, as described in the incorporated by reference patents and patent publication (see, e.g., US Patent Publication No. 20150298153), it is possible to adjust print parameters such that nozzle assignments, firing times, print grid definition, scan path location, and/or other parameters are adjusted in software to match the substrate error, essentially permitting virtual correction of fine substrate alignment, orientation, skew and/or scale error. Regardless of the mechanism, in order to perform correction, the error in substrate position, scale and/or skew is first identified, in this case, using alignment mark 243 (i.e., another fiducial). Recalling that the substrate in a typical application is typically transparent glass, this error detection can be performed by controlling the two transport paths so as to find and image the fiducial 243 using sensor 227; because the position of the fiducial 243 in the printer's coordinate system can now be measured, image processing techniques (recognition of the fiducial 243) coupled with position known from position feedback system for each transport path can be used to exactly determine the coordinates of the substrate (i.e., the fiducial) relative to the printer. As referenced above, using a complex fiducial or multiple fiducials, the image processing system can also identify other misalignments, such as error in substrate rotational orientation. By performing layer deposition (of all layers of the desired device) relative to the substrate's fiducials (e.g., 243), exactly layer registration can be achieved notwithstanding errors in substrate position and/or orientation, and other errors such as substrate edge nonlinearity, skew and/or scale error.

It should be observed that each of these various described processes can be performed with operator involvement, or (especially with aid of the techniques introduced herein), entirely automated under processor control. For example, in one implementation, the common coordinate point is established by an operator who views images provided by each camera and who manually engages each transport system so as to manually align the reticle imaged by each camera. Advantageously, instead, in one embodiment, this alignment action is performed entirely by image processing software, e.g., which uses image processing, a search algorithm and associated electronic control over each transport path; the image processing software causes one or more processors to detect reticle alignment and/or deviation between the images produced by the cameras, to drive the transport motion systems to reduce/eliminate this deviation, to read position data from the feedback system 215/219, and to “zero” the system to the common reference point. Image data from each camera is stored in a frame grabber circuit for each camera, and definition information for the common coordinate point is stored in processor-accessible non-transitory memory for use in position sensing.

Once substrate position and/or print parameters have been corrected dependent on the measured positional and/or orientation error derived from the one or more substrate fiducials 243, the substrate can, in one embodiment, then be advanced by the gripper as necessary for printing, for example, by being transported back and forth in an in-scan direction, as represented by double arrow 241.

The system depicted in FIG. 2A however can also potentially give rise to error if the height of the print head 223 (and each nozzle of the print head) above the substrate is not carefully controlled. This is explained relative to height indicators “h₀,” “h₁” and “h₂,” shown on the FIG. next to the print head 223, relative illustrated ejected droplets, and relative a droplet apparent velocity indicator “v.” Note that, once again, these things are drawn to aid explanation only, i.e., with a substrate moving along the “fast axis” in the direction of double arrow 241, the droplets and the substrate move relative to each other, and the droplets are ejected underneath the print head, toward the substrate and the drawing page). During a scan, as ejected droplets fall, the continuous motion of the substrate means that droplets will land on the substrate at locations dependent on (a) the substrate velocity, (b) droplet ejection velocity and (c) distance or height between the print head and substrate; variation in the height given a constant velocity therefore can directly translate to variation in droplet landing position on the substrate. In practice, the variation in landing position is typically on the order of one-fifth the variation in height, e.g., if a typical height of the print head nozzles above the substrate is two millimeters and height error and/or variation is on the order of 100 microns, this variation will translate to difference of about 20 microns in terms of intended droplet landing position. Note that the error can be much greater if height is not understood or effective height variation is greater.

To address this potential source of error, in one embodiment, height of a deposition source above the substrate is also calibrated, measured and controlled during deposition. In one embodiment, this calibration is performed using sensors 227 and 229 and the alignment system's fiducial (e.g., reticle 235). In another embodiment (introduced below in connection with FIGS. 4A-C), another sensor system (i.e., an absolute position sensor) can be used to measure height. In the case of the depicted system, the difference in print head height relative to camera on the print head assembly may not be accurately known and, as a consequence, it is advantageous to measure both of heights “h₀” and “h₁,” such that height “h₂” can be readily deduced from the height “h₀” measured using sensor 227 (i.e., according to “h₂”=“h₀”−“h₁”). In a printer embodiment, it may suffice for some implementations to simply “know” one height for the print head (e.g., if level control over the print head nozzle plate permits reasonable accuracy), while in other embodiments, it may be desired to measure absolute height of each nozzle orifice of each print head, i.e., such that differences in droplet apparent velocity from nozzle-to-nozzle can be precisely understood and otherwise mitigated. Note also that, as discussed in the incorporated by reference patents and patent publication, e.g., especially U.S. Pat. No. 9,352,561, each nozzle can present, due to manufacturing process corners, errors in nozzle position (“nozzle bow”), droplet ejection volume, droplet trajectory and/or droplet velocity, and that this error can present statistical variation; therefore, in one contemplated implementation, each nozzle can have a statistical model developed for droplets (i.e., as discussed by U.S. Pat. No. 9,352,561) with measured per-nozzle height factored into expected droplet landing position, to develop an accurate expectation as to where droplets from each nozzle will land relative to nozzle height and process corners affecting the particular nozzle. As introduced earlier, such information can be used to correct for deviation from desired height depending on implementation, e.g., by adjusting print head height (the print head, print head carriage or “ink stick” in one embodiment has an electronically-actuated, z-axis motor), or adjusting droplet velocity, ejection time, substrate position, nozzles used for deposition, droplet timing, cross-scan pitch, and/or other print parameters.

FIG. 2B provides further detail regarding height calibration and associated measurement in one embodiment. More particularly, FIG. 2B shows a system 251 which once again shows a print head carriage 205 and gripper 211. In this FIG., the gripper rides into and out of the drawing page (i.e., as indicated by the dimensional legend, riding on support guide 261) while the print head carriage 205 rides back and forth parallel to the x-axis, as indicated by numeral 207. As before, the print head carriage uses a positional reference system 215 (depicted as ruler markings) while the gripper uses positional reference system 219 (which this time, runs into and out of the drawing page, and is sensed by sensor 221 as the gripper moves). The reticle (i.e., the fiducial for linking of coordinate references for the split axes) is shown as lying in the xy plane, and is referenced by numeral 255; this reticle is held in place by a mechanical mount (i.e., an “L-bar” or equivalent), such that it lies directly within the optical path 259 of camera 253. In one embodiment, this mount can be a kinematic mount which is adjusted once (or infrequently) and which permits manual or automated coupling and decoupling on demand, with repeatable, accurate adoption of a consistent position relative to the field of view of the camera 253. The camera includes an electronic autofocus system that permits the focus of the camera (represented by cone-shaped optical path 259) to be adjusted to precisely image the reticle—in this case, the reticle can be a set of cross hairs on a transparent plate. Note that once again, items are depicted in this FIG. to assist with explanation and description, and actual implementation detail may vary.

Distance between the camera and the reticle is computed by adjusting the focus of the camera to obtain precise focus, which carries with it an associated, specific focal length (or “focal depth”); the height (“h₄”) is then directly computed from this focal length or focal depth by a processor (acting under the auspices of image processing software).

As with the print head assembly, the gripper 211 also mounts a camera 263 (upward facing, however), to find and image the reticle from beneath; once again, the image produced by the camera is focused (per depicted optical cone 265) and used to derive a height from this second camera to the reticle, once again based on focal length and processor computation of height “h₅” from this second focal length. The distance between cameras (in absence of a substrate, i.e., during calibration) is therefore given by the sum of these two heights, which likewise is computed by a software controlled-processor.

Still prior to the introduction of the substrate, the print head carriage is transported in a manner such that the print head 223 (i.e., an alignment mark or feature on the bottom of that print head) can be imaged by the lower camera 263; once again, focusing is performed, and is used to obtain a new focal length and associated height “h₆,” representing height of the print head above the upward facing (second) camera. The height of the print head (or a specific feature thereon), “h₁,” relative to the upper camera 253 can thereby be determined, i.e., by computing the value “h₁”=(“h₄”+“h₅”)−“h₆,” with such being stored in processor-accessible memory for future use.

When it is desired to perform printing, the reticle 255 and associated mount is removed (manually, mechanically or robotically) and the substrate 239 is introduced into the system. As with the height determination process referenced above, the downward-facing print head assembly camera is used to find position, this time by imaging a feature on the substrate (e.g., the substrate alignment mark 243 from FIG. 2A), and the proper focus of the camera is then identified, permitting processor computation of distance between the upper camera and the substrate “h₇” directly from the new focal length. However, the deposition source (i.e., the print head or any particular nozzle thereof) may not be at the same height as h₇ and may differ by tens of microns from this value. To address this, the stored value “h₁” is retrieved from processor-accessible memory and subtracted from the newly computed height “h₇,” to give the actual measured height “h₂” that the droplets are expected to fall before impacting the substrate.

Note that this system and associated computations can be performed either with or without the involvement of a human operator. That is, in one embodiment, focus of the various cameras is displayed on a monitor with an electronic focusing system being controlled by a human operator until a clear image is displayed. Alternatively, the focusing system can be automatically controlled by software using known image processing techniques to obtain correct focus, and to yield focal length and associated height; this can be preferred in some embodiments to speed the process and eliminate potential human error.

Note that many measurements can be performed using the system just described. For example, the upward facing camera mounted by the gripper can be used to measure height of each print head's nozzle orifice plate above the upward facing camera to detect height deviation between print heads and/or tilt/level of each individual print head. The upward facing camera can also be used to (via image processing), identify each nozzle's xy position, and to correct for errors in that position (e.g., see once again the teachings of the incorporated by reference patents and publication).

The depicted embodiment is suitable for many calibration procedures, but it still can be the subject of uncertainty that limits achievable accuracy and resolution of the measured heights—for example, changes in temperate, index of refraction of the reticle 255, and difficulty in objectively setting precise camera focus are all potential sources of error, even when performed under auspices of machine control. Furthermore, the required precision focusing can be time consuming, particularly when performed by a human operator. Finally, while the described system can readily measure height of deliberately-provided substrate fiducials, it can be more difficult to dynamically measure height at an arbitrary position of the substrate (i.e., based on difficulty or relying on image processing and variable focusing relative to potentially unknown features). For all of these reasons, several contemplated implementations make advantageous use of the embodiment described below in connection with FIGS. 4A-C, which provides for even faster, more robust calibration, alignment and measurement, particularly as applied to height measurement. Such a system decouples height measurement from the image focusing methodology referenced above, but still uses reciprocal height measurement systems to obtain results, with even greater precision and speed. This will be discussed further below in connection with FIGS. 4A-4C.

FIGS. 3A and 3B provide method step flow charts, 301 and 341, respectively associated with exemplary operations described above in reference to FIGS. 2A and 2B.

As indicated by FIG. 3A, a first method is presented as a flow chart, generally designated using numeral 301. A set of alignment processes can first be performed to link one or more axes of a fabrication apparatus 302, e.g., used for deposition of a material from a deposition source. For example, relative to the split-axis system discussed above, calibration can be performed for one or more motion systems, so as to link those systems in one or more of an “x-axis” dimension, a “y-axis” dimension and a “z-axis dimension.” In one example, it is assumed that the x and y transport mechanisms are to be corrected, but other dimensions can also be calibrated using the described techniques. Each assembly in two different transport paths is first moved to a predetermined position, for example, to an expected origin point where it is expected the two transport paths will intersect (303). The transported assembly for each path has an integral sensor which is then used to identify a common frame of reference (304); if necessary, a search algorithm can optionally be engaged, per numeral 305, to precisely locate the reference point following rough alignment. Also optionally, position feedback is obtained for each of the transport paths or multiple axes, per numeral 309, to measure track or guide position at the common point; as indicated by numeral 310, this feedback can optionally be provided by alignment marks associated with each transport path. Also optionally, as denoted by numerals 311, 312, and 313, the alignment process can feature independent alignment of each sensor to an intermediate point (e.g., a fixed reference associated with a fabrication table, or the reticle referenced earlier), alignment of one sensor to the other (e.g., the reticle is mounted by one of the sensors, or conversely, imaging techniques are used to find the other sensor), or coaxial optical alignment (e.g., images produced by each of two sensors are overlaid until they align, to define a common optical axis. Other techniques are also possible. At the point where alignment is achieved, position of the assembly on each respective transport path is used to establish a coordinate system for deposition/fabrication, i.e., with transport paths aligned to a common axis, per numeral 315. As indicated by numeral 316, this process can be performed to link/align additional axes together or to an existing coordinate system as desired (e.g., z-axis height, or another dimension or set of dimensions). Once the desired or needed number of alignment processes has been performed, the system is in a state where it has been calibrated 317.

Numeral 318 denotes an offline/online process separator line, i.e., the steps above the line are typically performed offline while the steps below the line are typically performed online during fabrication. For example, as represented by numeral 321, the steps below the separator line can be performed online for each new substrate that is introduced into a fabrication apparatus as part of an assembly-line style process. As each substrate is introduced 322, the transport mechanisms are used to detect one or substrate fiducials 323, permitting alignment of that individual substrate (or a product thereon) to the coordinate system of the printer and to intended recipe information. This then permits derivation 325 of correction or offset information. For example, once location, orientation, scale and/or skew error of the substrate have been identified, corrections and offsets can be stored and/or used to correct substrate position/orientation or otherwise adjust 326 print parameters. Finally, with a correction strategy employed, fabrication (e.g., printing, 327) then occurs, to precisely deposit material in the desired position, as pertinent to the precision fabrication process. As denoted by ellipses 328, the method can then continue (for example, applying post-printing processing steps to finish a layer of the deposited material).

FIG. 3B shows a more detailed alignment process 341. As indicated by numeral 343, in one embodiment, a print head (PH) camera is first parked in a maintenance bay or at a servicing position (for example, in a “second volume” or enclosure adjacent to a first volume or enclosure in which printing is performed) and a reticle is mounted manually or robotically to the PH camera. Note that this is not required for all embodiments, i.e., in a different implementation, a reticle can be mounted in place or can be robotically pivoted or engaged to move into a proper position at any point in time. Irrespective of specific engagement mechanism, with the reticle in place, the PH camera is then moved into a position where it is ready for coaxial optical alignment with a second (gripper) camera system. The PH camera is engaged to image/sense 345 the reticle, with camera and/or reticle position adjusted 347 to approximately center the reticle so that is it clearly in the field of view of the PH camera and focus then being adjusted 351; as noted earlier, focal length determination permits height measurement 356 of the reticle relative to the PH camera. The second (gripper) camera system is then also moved 357 to this designated position and used to image 359 the reticle from beneath; as noted previously, the reticle can be a set of crosshairs on a transparent slide, preferably with an index of refraction that is approximately the same as the atmosphere in which printing/fabrication is to occur. The gripper camera system (i.e., gripper position and/or PH camera position) is then adjusted 361 so that images produced by each camera system exactly superimpose (e.g., as determined by an operator or by image processing software). At this position, the focus of the gripper camera system is adjusted, per numeral 361, to permit derivation of height of the reticle relative to the gripper camera system from the focal depth. As noted before, this permits identification of the vertical (z-axis separation) between the PH camera and the gripper camera system. Note that FIG. 3B highlights several options associated with these processes; for example, in one embodiment, this height determination process is coaxial 346 for the PH camera and the gripper camera system; also, in one embodiment, each of the PH camera and the gripper camera systems includes two cameras, for example, a low resolution camera to approximately find the reticle, and a high precision camera to as to improve alignment accuracy and focus determination (348/362). As noted, a human operator can provide systems' control for purposes of alignment and/or focus, e.g., by viewing (352/364) images on one or more monitors and by responsively controlling the system and/or focus; in another embodiment, such adjustments can be automatically performed and controlled (353/365) by software.

With the distance between cameras identified (i.e., “h₄”+“h₅” as labeled in FIG. 2B), per numeral 369, the gripper camera system is then used to image the print head itself, or a reference such as a fiducial on the print head; once again, focus adjustment 371 is performed or another technique is used to measure height from gripper camera system to the print head reference (i.e., “h₆” from FIG. 2B), per numeral 372. A processor/software then computes height difference “h₁” between the print head reference and the PH camera (i.e., by taking the measured distance between cameras “h₄”+“h₅” and subtracting this new value “h₆” from it, and storing the result). If desired, such measurements can be taken, for example, to adjust multiple print heads to the same height or each print head so as to have a level lower plate (i.e., nozzle orifice plate); other measurements can also be performed using the gripper camera system, e.g., to calibrate each nozzle's position, as desired.

During printing, as a new substrate is introduced, the system proceeds per numeral 373 to find a visual reference (substrate fiducial) for that new substrate, using the PH camera, and it once again adjusts focus 374, identifies consequent focal length, and uses this to derive vertical separation “h₇” between the PH camera and the substrate at this position, per numeral 376. With this distance identified, the processor then computes vertical separation between the print head and the substrate per numeral 378 by subtracting the previously stored value “h₁” from “h₇” (i.e., the previously stored value “h₁” is equal to “h₄”+“h₅”−“h₆”). As depicted variously by a set of correction efforts 381, possible reactions to the identified height include automated or manual (a) adjustment of print head height or level (383), (b) adjustments to drive voltage, so as to increase or decrease droplet velocity (384), (c) adjustment of the timing of nozzle firing triggers (385), i.e., such that droplets are ejected at their native effective trajectory either earlier or later, so as to arrive at the desired landing location, and/or (d) adjustment of which nozzles are used to print (386), i.e., so that droplets from other nozzles are used so as to mimic the desired landing location. Other techniques can also be used, as alluded to earlier.

Reflecting on the described operations, a set of alignment techniques can be used to co-locate two or more transport systems relative to a common reference point. A position feedback system is optionally used such that a fabrication apparatus can position a deposition material source and/or substrate so as to deposit material as desired on any given portion of the deposition substrate. A height calibration system, optionally relying on the same elements as used by a system for alignment of the two transport systems, can then be used to calibrate height of a deposition source relative to the deposition substrate; finally, the substrate position, source height, and/or deposition particulars can be adjusted so as to provide more accurate control over the precise point of deposition of deposited material. In various embodiments, the system that performs alignment between transport paths, and the system that performs source height calibration, can be independent and used independently of each other, and they can each be used with other types of calibration systems.

### D. A Second Embodiment—Precision in Source Height Determination and Dynamic Measurement

As noted above, the embodiments described with reference to FIGS. 2A-3B are suitable for a number of implementations, but can still be the source of unintended error. FIGS. 4A-4C are used to introduce another, alternative embodiment that provides for more accurate and faster height measurement, as well as for dynamic height measurement.

A fabrication apparatus is first initialized prior to introduction of a substrate, per numeral 403; as part of this initialization process, an automatic calibration routine is run, 405, which performs the calibration and alignment steps as described above and below, completely under the control of software and at least one processor. These steps permit the system to associate its transport axes with a frame of reference and, consequently, to be able to transport a deposition source and substrate relative to each other such that material can be deposited on any desired position of the substrate. In an embodiment which attaches and removes components such as a reticle, as described above, or which features a camera assembly which is attached to and detached from a print head carriage, the system is optionally controlled so as to divert the print head carriage to a maintenance bay where the appropriate tools are automatically exchanged with a variable tool mount under automated robotic control. Once again, the use of a maintenance bay, or transport of a print head carriage to a maintenance bay, is not required for all embodiments; in other embodiments, the pertinent tool can be engaged in-situ or can be permanently mounted in a manner that does not interfere with online printing. Each tool (and the print head carriage) is configured with electronic, magnetic and/or mechanical interfaces which permit this to occur, with the selection of the appropriate interface being an implementation choice. To this end, in one embodiment, a kinematic mount is employed, which provides for magnetic engagement of the reticle or other appropriate tool with a high degree of reliability and repeatability, e.g., to within microns. To engage the tool, the print head carriage can optionally be caused to robotically or otherwise to engage the tool (the reticle) in exactly the right position with the tool magnetically-settling to a predetermined position with at most micron-scale deviation. Optical alignment between transport axes is then performed using this tool as described in the previous embodiments, for example, by moving one or both transport paths to a position where respective camera images feature an aligned, coaxial reticle, and using position information/position feedback information for each transport axis to define a common coordinate point, thereby establishing a xy coordinate system for printing/fabrication/processing. As will be described below, this calibration process then uses a separate set of laser sensors to very quickly measure z-axis height of the print head and/or or one or more features associated with the print head. Several processes are performed using these lasers/sensors, including (a) using the cameras to identify approximate xy laser measurement position coordinates for each laser/sensor, (b) using a target (e.g., a bore or protrusion to establish an xy coordinate location for each laser/sensor with precision, (c) measuring print head height, or levelness for each print head (and optionally for each nozzle), (d) measuring height of a print head standard (to be discussed below), and (e) periodically recalibrating the lasers/sensors relative to each other for accuracy, or relative to xy position, to account for drift. These various operations will be discussed below. Optionally, as mentioned, one or more of these processes can also use one or more tools which are robotically or otherwise engaged and disengaged as appropriate. Note again that, as part of the auto-calibration routine, a number of other system measurements can optionally be performed, for example, measuring each nozzle's position, measuring and/or comparing print head height relative to other print heads, and so forth. Note also that the automatic calibration routine 405 in one embodiment is run once, at initial system installation; in another embodiment, it is run on an intermittent basis (e.g., a periodic basis, such as every day or hourly). In still another embodiment, the calibration routine is run in response to system events, for example, in response to power-up, in response a periodic quality tests run by software which returns a deviation from a fixed target by more than a threshold amount, each time a print head or “ink stick” is changed, or on an ad hoc (e.g., operator-triggered) basis. Also note that an exemplary system can feature multiple different calibration routines which employ various combinations or subsets of the measurement processes discussed above, as pertinent to the design or calibration event. Whichever calibration options are used, the initial (offline) auto-calibration sequence is typically planned to make the system ready to receive a series of substrates.

In an assembly-line style process, each substrate in the series will typically receive exactly the same fabrication design pattern or “recipe,” which the system attempts to align/position properly using the fiducials present on each substrate. A given fabrication process is used to form a single layer, typically microns thick (e.g., between 1-20 microns in thickness). In the case of an OLED display fabrication process, for example, materials can be used to build layers which contribute to the operation of an individual light emitting element, including without limitation an anode layer, a hole injection layer (“HIL”), a hole transport layer (“HTL”), an emissive or light emitting layer (“EML”), an electron transport layer (“ETL”), an electron injecting layer (“EIL”), and a cathode layer. Additional layers can also or instead be fabricated, such as hole blocking layers, electron blocking layers, polarizers, barrier layers, primers and other materials can also be included. The design of the light emitting element can be such that one or more of these layers are restricted in area so as to establish a single light emitting element for a single pixel (e.g., a single red, green or blue light emitting element) while one or more of these layers can be deposited so as to establish “blanket” coverage that cover many such elements (e.g., providing a common barrier, encapsulation layer or electrode, or other type of layer). In operation, the application of a forward bias voltage (anode positive with respect to the cathode) will result in hole injection from the anode and electron injection from the cathode layer. Recombination of these electrons and holes results in the formation of an excited state of the emitting layer material which subsequently relaxes to the ground state with emission of a photon of light. In the case of a “bottom emitting” structure, light exits through a transparent anode layer formed beneath the hole injection layer. A common anode material can be formed, for example, from indium tin oxide (ITO). In a bottom emitting structure the cathode layer is typically reflective and opaque. Common bottom emitting cathode materials include Al and Ag with thickness typically greater than 100 nm. In a top emitting structure, emitted light exits the device through the cathode layer and for optimum performance the anode layer is highly reflective and the cathode is highly transparent. Commonly-used reflective anode structures include a layered structure with a transparent conducting layer (e.g. ITO) formed over a highly reflective metal (e.g. Ag or Al) and providing efficient hole injection. Commonly-used transparent top emitting cathode layer materials providing good electron injection include Mg:Ag (^{˜}10-15 nm, with atomic ratio of ^{˜}10:1), ITO and Ag (10-15 nm). The HIL is typically a transparent, high work function material that readily accepts holes from the anode layer and injects holes into the HTL layer. The HTL is another transparent layer that passes holes received from the HIL layer to the EML layer. Electrons are provided to the electron injection layer (EIL) from the cathode layer. Electron injection into the electron transporting layer is followed by injection from the electron transporting layer to the EML where recombination with a hole occurs with subsequent emission of light. The emission color is dependent upon the EML layer material and for a full color display is typically red, green or blue. The emission intensity is controlled by the rate of electron-hole recombination, which is dependent upon the drive voltage applied to the device.

To build a desired layer at system run-time, the substrates are sequentially introduced to fabrication apparatus. For organic materials deposition, the fabrication apparatus can have a printer that deposits a liquid film in the presence of a controlled environment. In FIG. 4A, numeral 407 refers to layer printing and/or fabrication in a first controlled environment while numeral 409 refers to ensuing processing either in the first or a second controlled environment, i.e., each maintained to as protect deposited sensitive materials from degradation from exposure to oxygen, moisture and other contaminants until those materials have been cured or otherwise processed to become permanent or semi-permanent. As it is introduced, a substrate is first aligned to the printer reference system, as described elsewhere herein, and optionally height-measured to correct for per-substrate variation, per numeral 411. For example, a misaligned substrate can be repositioned by mechanical handlers or fine position transducers can be used to adjust substrate position and/or orientation; in addition, a print recipe or print parameters can be adjusted in software to correct printing to match xyz misalignment. Optionally, height variation can be factored into deposition parameters (including substrate position and/or print head height and/or software parameters and nozzle control), which can then be responsively adjusted (per numerals 413/414) for the specific substrate to provide more accurate control of printing. Just as with the online process, as referenced by numerals 415 and 416, in one embodiment, this adjustment is automated before printing starts, while in another, height is dynamically measured and dynamically used for correction. Printing then occurs according to desired parameters, as indicated by numeral 417. Following printing, the deposited film (e.g., a continuous liquid coat) is processed, such as by being dried or cured, as indicated by numeral 424. In one embodiment, this can be performed directly by a tool carried by the print head transport mechanism, for example, a transported ultraviolet light source; in other embodiments, such processing is performed in a different chamber (e.g., containing the same or a different atmospheric content, as noted).

As indicated by numerals 420 and 421, for any of these layers, it is possible to perform deposition in a controlled environment, meaning an atmosphere that is controlled in some manner so as to exclude undesired substances or particulate. In such a circumstance, the printer can be completely enclosed in a gas chamber and controlled to perform printing under such controls. In an embodiment, the atmospheric content is different than normal air, for example, comprising an enhanced amount of nitrogen or a Noble gas relative to ambient atmosphere. The automated calibration, alignment and measurement techniques described herein are optionally performed within such a controlled atmosphere (i.e., on an automated basis not requiring involvement of a human operator). Numerals 425, 426, 427, 428 and 429 indicate a number of further process options, for example, the use of two different controlled atmospheres (425) (e.g., one for printing and one for processing), the use of a liquid ink in the deposition (printing) process (426), the fact that deposition can occur on a substrate having underlying geometry (e.g., deposited structures), or a curved or other profiled substrate (427), the fact that encapsulation and/or printing may leave select layers exposed in certain portions of the substrate, such as electrodes (428), and optional process control to adjust print parameters in the area of a layer's border, for example, to print a specific edge profile (e.g., this is particularly useful to tailor the edge of an encapsulation or other “blanket” layer), 429; other optional techniques can also be combined with these things.

Once the desired layer is processed into a permanent or semi-permanent form, the particular substrate can either be returned to the printer or a connected fabrication apparatus to receive additional layers (or processing), or it can be removed from the controlled environment for further processing or finishing, as indicated by numeral 431.

As noted earlier, in a precision environment such as the one just described, particularly for pixel fabrication (e.g., where picoliter scale droplets are to be precisely positioned within fluidic “wells” that are micron scale (e.g., tens of microns wide and long), and in which a planned amount of the deposition liquid, e.g., “50 picoliters”) must be delivered within that well without significant variation, it can be important to accurately calibrate height and to (statically or dynamically) measure and correct for height variation. For example, in a system where nozzle or print head height relative to other nozzles or print heads varies by tens-to-hundreds of microns, positional error caused by the height variation can be on the order of twenty percent or more of the height error or variation; this can be unacceptable for many applications. To address this, FIG. 4B shows an alternative height calibration and measurement system 441 based on the use of high-precision sensors. Such a system generally provides greater accuracy, is more amenable to completely automated control, and is able to both perform fast measurement and on-the-fly measurement to provide a dynamic understanding of height variation. There are several components represented in FIG. 4B, including a print head (PH) camera assembly 443, a gripper camera assembly 445, a print head 455, a print head assembly fixed reference block 471, a print head laser sensor 461, a gripper laser sensor 463, and a gauge block 467 (used for calibration).

Operation of the various components depicted in FIG. 4B is as follows; first, the PH camera 443 and gripper camera assembly 445 are each optically aligned in the manner previously described. That is, each camera is used to image a reticle (451/451′) along respective optical paths 449 and 450. Numerals 451 and 451′ can refer to the same common reference mark (e.g., to a common reticle), or to respective reference marks (e.g., having a known positional relationship). Unlike some of the embodiments discussed earlier, however, precise focus, and precise focal length of the optical paths 449/450 are not closely associated with calibration results. That is, as before, a digital image output of each camera is fed to a frame grabber and compared, but image processing software simply identifies positional overlap of the reticle (e.g., crosshairs) from each image and adjusts the two transport paths until their respective positions are aligned (e.g., the reticle is fixed to the PH camera 443 and the gripper camera assembly 445 is moved to center the reticle in its field of view). Note that the depicted cameras each include a coaxial light source 447 and a beam splitter 448 to direct light from the light source to illuminate the reticle and to provide return light to an image sensor within camera 443/445. As before, each camera assembly can also optionally feature dual low and high resolution imaging capabilities and an electronically-controlled autofocus mechanism, controlled by the image processing software (or other software) to obtain a clean image of the reticle. The image processing software, as before, detects proper positional alignment of the cameras, and the measurement system captures precise position of each transport path corresponding to this alignment to “zero” or to otherwise define the origin of the coordinate system.

Once xy alignment is accomplished, the transport systems of the fabrication apparatus are controlled to move the PH camera 443 to approximately “find” the gripper's z-axis high precision sensor 463, in terms of xy coordinates and, conversely, the transport systems are also moved to cause the gripper camera system 445 to “find” the print head assembly's z-axis high precision sensor 461, in terms of xy coordinates. As noted, in this embodiment, each high precision sensor can be a laser sensor that measures distance, e.g., oriented to measure height. To perform the location function, an alignment feature representing a detectable height profile (a bore or protrusion or other detectable height feature) is positioned for each camera in a manner that can be imaged by both camera and associated z-axis laser sensor. For example, in one embodiment, a low resolution camera or image from the gripper camera system 445 is used to search for and find, via automated image processing, the recognizable aperture or protrusion (e.g., mounted to the print head assembly, though it can instead be mounted anywhere that can be imaged by both the gripper camera system and gripper's z-axis laser sensor 463). Once this feature is found and centered, a high resolution camera or image for the same camera system (e.g., the gripper camera system) is then used to more accurately identify position of the recognizable feature or protrusion, and the image processing software then stores its xy coordinates; because the coordinate system for the printer has already been established, the transport system is then used to approximately position the gripper's z-axis laser sensor 463 where it can scan the recognizable aperture or protrusions, and establish an exact midpoint of that recognizable aperture or protrusion. A precise xy coordinate point is associated with this position, and based on the difference between the camera-determined xy coordinate position of the recognizable aperture and the xy coordinates of the center point of that recognizable aperture or protrusion provided by the z-axis laser sensor, a precise xy distance between the gripper's z-axis laser sensor 463 and the gripper camera system 445 is derived and stored for use in the various calibrations. Conversely, the same process is then performed using the PH camera 443 and the print head's z-axis laser sensor 461 to find a common feature or protrusion, and to find and store a precise relative xy distanced between the print head's z-axis laser sensor 461 relative to the print head's camera system 445. This distance calibration can then be used to facilitate the dynamic and other measurements referred to earlier. For example, during run-time, to measure height at any portion of the substrate, the transport systems of the fabrication apparatus are simply driven in a manner that will position the print head's z-axis laser sensor 461 over any desired point of the substrate to take a height reading; conversely, as desired (i.e., typically in an offline process, or between substrates), the system can position the gripper's z-axis laser sensor 463 so as to image any desired feature associated with the print head(s).

Note that while a laser sensor has been described, any high precision sensor can be used, subject to suitable adaptations pertinent to the sensing technology at issue, which are within the capabilities of one having ordinary skill in the art. In connection with the laser-based sensor example related above, one sensor found suitable for the described purposes is a laser sensor available from MICRO-EPSILON, USA, having offices in Raleigh, N.C. A suitable sensor is one that can measure height variation within a range of three millimeters or less, with sub-micron measurement precision.

Note that the right-side of FIG. 4B illustrates that each laser sensor 461/463 detects a height (“h₉”/“h₁₀”) using a beam directed at an angle 464/465. In this regard, the mentioned sensors preferably operate using a reflectance measurement approach, e.g., since deposition is to be performed on a glass or transparent substrate in one embodiment, “head-on” measurement potentially introduces unwanted reflection noise caused by the index of refraction of the imaged material. To address this, each sensing laser is preferably of a type that directs light at an angle (e.g., “α”) in a manner that minimizes backscatter and unwanted reflections. The right side of FIG. 4B also shows a gauge block 467 used for calibration; the gauge block 467 typically features a body which can be mounted to the system, as well as a tongue 469 of precisely known thickness (“h₈”). In this regard, it was earlier mentioned that during offline calibration, certain tools can be selectively used (e.g., engaged by manual and/or articulated and/or robotic engagement, or mounted at a fixed location that does not interfere with online fabrication) for purposes of specific calibration; the gauge block 467 is one such tool. In one embodiment, this tool is also mounted at a known location relative to the printer support table or chuck, for example, either permanently outside the substrate conveyance path (e.g., at a xy position still reachable by both laser sensors 461/463), or in a position that can be selectively robotically engaged and disengaged, for example, via another kinematic mount. In this regard, the precise thickness is a known value, such as “1.00 microns,” and is placed in a position where it can be sensed by each laser sensor. Each laser in succession is driven to the appropriate location by software as part of a calibration routine, and used to measure height between the laser sensor and the corresponding side of the tongue, e.g., to measure heights “h₉” and “h₁₀.” Since the thickness of the tongue “h₈” is precisely known, the calibration software can immediately calculate the distance between the two laser sensors, e.g., “h₉”+“h₁₀”+1.00 microns (this analogous to the computation of “h₄”+“h₄” from FIG. 2B except that it can be performed almost instantaneously once the laser sensors are driven to the correct position; in fact, as with other measurements herein, preferably, these measurements are taken in very close succession to minimize any possibility of temperature or other drive affecting measurements). Note also that because this measurement scheme does not rely on achieving “precise focus” (i.e., which may be subjective, or take time, or otherwise be potentially subject to error), it is typically substantially more accurate than the scheme discussed earlier.

Many of the measurements performed are thereafter analogous to those discussed earlier.

For example, the gripper's laser sensor is used to image an orifice plate 457 riding on the bottom of the print head 455 and develop a height measure (e.g., “h₆” from FIG. 2B, except that this measurement is now taken from the gripper's laser sensor 463). Since however the distance between laser sensors is precisely known, calibration software can immediately compute the height difference of the print head orifice plate 457 relative to the print head's laser sensor 461, i.e., by subtracting the height to the print head orifice plate 457 from the distance between sensors, i.e., from the quantity “h₉”+“h₁₀”+1.00 microns. This value can then be stored and used as before, e.g., to enable precise measurement of height of the print head orifice plate 457 above the substrate 459 at any point in time (e.g., dynamically, during printing, on an automated basis) by simply measuring the substrate at a desired xy coordinate point using the print head laser sensor 461, and by subtracting the stored height difference of the print head orifice plate 457 relative to the print head's laser sensor 461. Again, because dynamic focus is not used for height measurement, and because the employed sensors are precision devices and provide immediate readings, measurement is immediate.

FIG. 4B also shows a print head assembly fixed reference block 471 and associated fiducial 472. Briefly, these items are optionally used to provide a fixed reference point relative to the print head assembly; advantageously, at the time of initial and/or other offline calibration where the gauge block 467 is featured, the distance from the gripper's laser sensor 463 to the fiducial 472 is also at this time measured by the gripper's laser sensor 463 and stored. This measurement and stored value can be used to provide a processing shortcut during later measurements. For example, with respect to a fabrication apparatus based on an ink jet printer, print heads and/or ink sticks may be frequently swapped or varied, each one potentially presenting new height differences and potential errors that ought to be measured and then factored into printing, printer adjustment, or print process adjustment. The use of the fixed reference block 471 and associated fiducial enables use of a second, abbreviated calibration process, e.g., rather than repeating all of the steps just mentioned; at the time of swapping, the gripper's laser sensor 463 can be used to image both each new print head orifice plate and the fiducial 472 to derive a height difference. This height difference can then be used to immediately derive height of the new print head by reference to the difference relative to the fiducial (and the prior print head's height different relative to the fiducial). Thus, without need of the gauge block or other measurements, the system can immediately derive a new print head height value based on a shortened calibration sequence, further enhancing device up time. Note that not all embodiments require this optional technique.

FIG. 4C shows a method 471 featuring some of the measurements and other steps just described. First, as indicated by numeral 473, two transport paths are aligned to a common reference point, for example, using print head and gripper cameras and a reticle as described. Per numeral 475, with a coordinate system thereby established, the system searches for a xy coordinate for a first high precision sensor, for example, for a first laser. With this information known, that high precision sensor is then precisely placed relative to a standard (e.g., the gauge block 467 from FIG. 4B) and used to obtain a height measurement relative to that standard, per numeral 477. The system also searches per numeral 478 for a xy coordinate for a second high precision sensor, for example, for a second laser (e.g., mounted relative to a different transport path). With this information known, that second high precision sensor is then precisely placed relative to the standard (e.g., the gauge block 467 from FIG. 4B) and used to obtain a height measurement relative to that standard, as indicated by numeral 480. Based on these measurements, a processor acting under auspices of calibration software then computes a height difference between the two high precision sensors (e.g., from the first laser to the second laser), 481, enabling height measurements from the two high precision sensors to be precisely related to each other; as before, this can be found according to the formula “hₜₒₜₐₗ”=“h₈”+“h₉”+“h₁₀” (483). As indicated earlier, a fixed reference such as fiducial 472 can also optionally be provided for and measured, with a resulting measured height then stored for future use, as indicated by numerals 485, 487 and 488. One of the high precision sensors (e.g., associated with one transport axis such as the gripper, or another sensor such as a camera) is then used, as indicated by numeral 491, to find the source, and the second high precision sensor is used to measure distance between it and the deposition source (as indicated by numeral 492). A height difference presented by the source is thereby determined (493), e.g., relative to the distance between the two sensors or relative to the fixed reference. As desired, the first high precision sensor is then used (e.g., dynamically or otherwise) to measure height relative to a deposition target, such as a substrate, per numeral 495; finally, as indicated by 497, the system measures and stores height difference between the source and deposition target, and takes appropriate correction/adjustment actions, i.e., as indicated by 498.

Again reflecting on some of the components and structures just discussed, in one embodiment, z-axis measurement can be immediately performed with precision, in a more accurate manner than per earlier-discussed embodiments. Optionally, a fabrication system is first calibrated to identify a xy or similar coordinate system. High precision sensors associated with each transport path are then engaged and used to measure height difference between the two high precision sensors. These two sensors can be used, via a series of measurements, and through the optional use of certain features, as described, to both provide fast, accurate measurement of height difference between deposition source and target in a fabrication system (or between a tool and a target, for example). This process can be fully automated and avoids potentially subjective or time-consuming steps and potential limits to resolution based on judging proper focus. When coupled with the optional xy coordinate calibration and alignment scheme, and with the precise identification of sensor position relative to an xy coordinate, the disclosed techniques permit automatic, accurate z-axis measurement on a basis that is both immediate and dynamic, and can be used to measure any part of a deposition target (or other fabrication or manufacturing apparatus components).

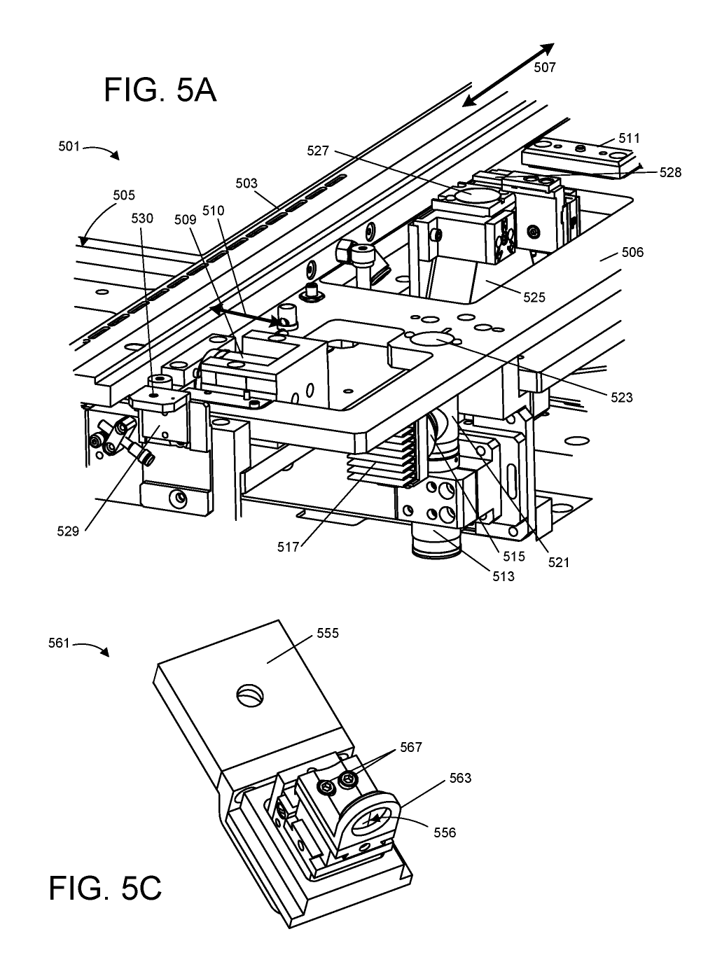

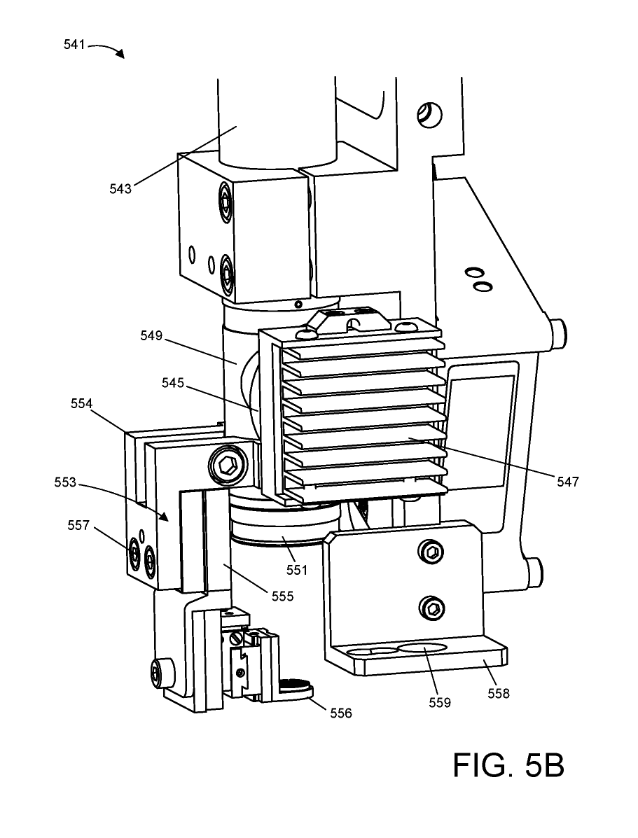

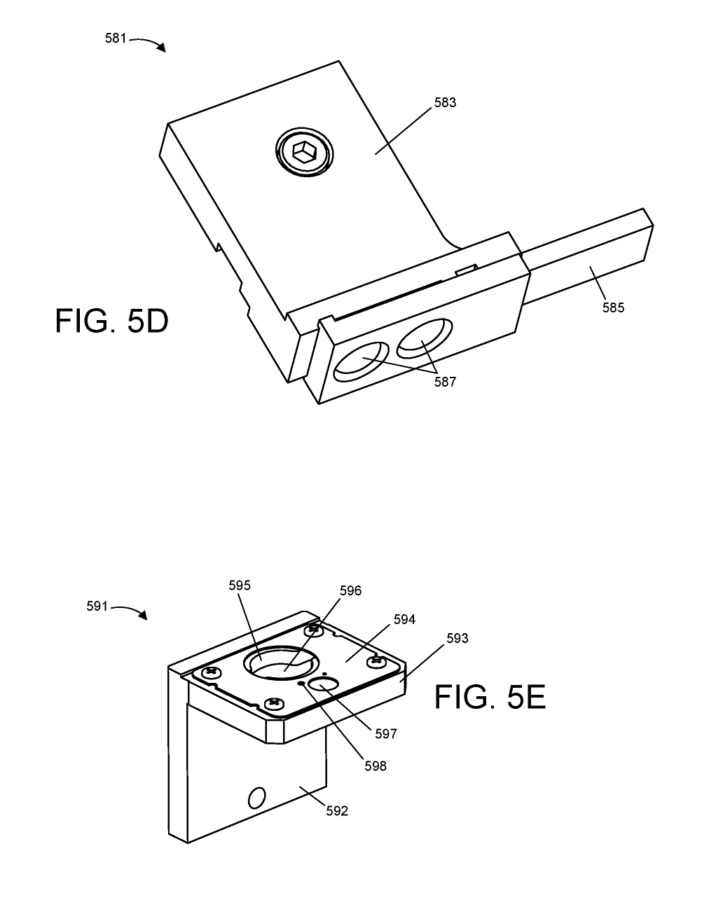

FIGS. 5A-5E are used to provide some additional information regarding a still more detailed embodiment.

First, FIG. 5A depicts part of a fabrication apparatus 501 comprising a vacuum bar 503 (used to engage a substrate) and a printer support table or chuck 505. The vacuum bar forms part of the gripper, with both the gripper (e.g., gripper frame 506) and vacuum bar 503 moving back and forth in the general direction of double arrows 507 to transport substrates. The vacuum bar is coupled to the gripper frame 506 by a set of linear transducers (only one 509 is seen in the FIG), which articulate the vacuum bar and the substrate via linear throws in direction of double arrow 510; common mode drive of these transducers can linearly offset the substrate in the direction of double arrows 510 while differential mode drive of these transducers can rotate the substrate about a floating pivot point 511 (e.g., this can be used to perform selective substrate position correction as referenced earlier). The depicted fabrication apparatus 501 also shows an upward-facing camera or gripper camera system, comprising a camera 513, a light source 515 and an associated heat sink 517. The light source and the previously-mentioned beam splitter (not seen, but mounted within an optical path of the camera at approximate optical axis location 521) is used to direct light from the light source upward through an aperture 523 in the gripper frame, for purpose of providing optical measurements alluded to previously. The gripper frame 506 also mounts a high precision sensor 525, such as the previously-mentioned laser sensor from MICRO-EPSILON, oriented to face upwards and to measure height of objects through aperture block 527. This aperture block can be used for selective attachment (robotic or otherwise) of a gauge block 528, e.g., it presents a magnetic plate that forms part of a kinematic mount, for purposes referenced earlier. Notably, the gripper frame 506 is also shown to mount a calibration block 529 that provides a recognizable aperture/protrusion 530 for imaging by a print head camera (not shown in FIG. 5A) and by a high precision sensor mounted to a print head (also not show in FIG. 5A). This calibration block and associated reference features (fiducials), as discussed previously, is used to precisely identify position of the high precision sensor mounted to the print head relative to the camera mounted to the print head, in terms of xy coordinates.

FIG. 5B shows a camera assembly 541 that is mounted by a print head carriage (not shown). This assembly includes a camera 543 oriented to point downward and a light source 545 and associated heat sink 547. As before, a beam splitter within the camera's optical path (roughly at location 549) directs light from the light source downward through a lens 551 and receives return image light that is sensed by the camera 543. A kinematic mount 553 is also depicted, comprising a permanently mounted “L-bar” 554 which provides a highly repeatable connection with a detachable carrier 555; this detachable carrier in turn carries a lens-mounted reticle 556, as referenced previously. During calibration, the camera images the reticle (while the upward-facing camera 513 from the assembly of FIG. 5A images this same reticle 556 from below). As noted earlier, the kinematic mount permits highly repeatable attachment and detachment of the reticle's lens assembly for purposes of xy coordinate system definition, as well as other measurement tasks, as referenced earlier. In one embodiment, the kinematic mount can be occasionally recalibrated using adjustment screws 557, either by a human operator or by (in one embodiment) electronic actuation performed to calibrate reticle position relative to an imaged target. FIG. 5B also shows a calibration block 558 used to provide another recognizable aperture/protrusion 559, for imaging by a gripper system camera (i.e., by camera 513 from FIG. 5A) and by a high precision sensor mounted to a gripper (i.e., high precision sensor 525 from FIG. 5A). This calibration block and associated fiducials, as discussed previously, are used to precisely identify position of the precision sensor mounted to the gripper relative to the camera mounted to the gripper, also in terms of xy coordinates.

FIG. 5C provides a close-up perspective view of the reticle's lens assembly 561, also seen in FIG. 5B. This assembly comprises the aforementioned carrier 555, which also provides part of the kinematic mount for rapid and accurate (e.g., manual or robotic) attachment and detachment or other positioning/engagement of the reticle's lens assembly. The assembly also includes an optical lens 563 that bears the reticle 556, with precise positioning of the lens being infrequently fine-tuned by manual adjustment of alignment/mounting screws 567. As noted earlier, the reticle (assembly) is advantageously designed for rapid (e.g., robotic) attachment and detachment or other automatic positioning/engagement, to provide for a fully automated calibration and measurement process.

FIG. 5D provides a close-up view of a gauge block 581. This block is seen to consist of a main body 583 that, similarly, provides half of a kinematic mount, adapted for easy, repeatable, attachment and detachment and/or other selective engagement or use. More particularly, this assembly is selectively engaged to place a tongue 585 directly in the optical path of the precision height sensor of the gripper, for example, for selective attachment and detachment to a reciprocal memory of the kinematic mount formed by aperture block 527 from FIG. 5A. Naturally, many design alternatives exist. FIG. 5D also shows two clamping screws 587 for the tongue. Although not shown in FIG. 5D, the kinematic mount features an adjustable slide plate, which can be used to provide infrequent manual fine-tuning of precise tongue position relative to the mounting of the gauge block by the gripper frame.

Finally, FIG. 5E shows an example of a reference block 591 used to provide an example of a calibration block for the various cameras and high precision sensors. In this particular example, this calibration block can be exactly that device represented by numeral 529 from FIG. 5A. [The design of the calibration block 472 from FIG. 4B is also similar.] The calibration block is “L-shaped” and comprises mounting plate and target plate portions 592 and 593, the latter provide a calibration reference for xy distance between a camera and associated high precision sensor. A plate of polished sheet metal (e.g., stainless steel or another surface) is used to provide a highly reflective surface for imaging by the precision sensor. Briefly, as discussed earlier, a protrusion/aperture (in this case an aperture) is imaged by first a lower resolution camera, second by a high resolution camera and finally by a high precision sensor associated with a given one of the transport axes; positions from the position feedback systems associated with the transport axes are read at positions where a camera and its associated high precision sensor detect the center of this aperture 595. These positions are then used to compute xy offset between these two measurement devices. Note that advantageously, the aperture 595 does not represent a full bore through the target plate portion, which might give an inconsistent (i.e., noisy) sensor reading—rather, all that is necessary is that this target plate portion provide a target that provides for clean high precision sensor signal discrimination in a manner that permits bore location and identification of bore center. As noted by numerals 597 and 598, the target plate portion can provide additional, variable sized apertures for additional calibration functions.

By providing calibration and measurement references in the manner described, the components presented in FIGS. 5A-5E provide an effective, highly accurate means of determining multi-axis (e.g., x, y and z) position calibration and measurement in a high precision manufacturing system. As indicated earlier, this provides for much finer control over deposition parameters, such as intended landing position of deposited material. In one embodiment, these techniques can be applied to facilitate precision droplet placement by an industrial split-axis printing system.

Note that the described techniques provide for a large number of options. First, it is noted that while several embodiments have been described which are based on a printer (e.g., an ink jet printer), the techniques described herein are not so limited; to provide but-one example, the described techniques could be applied to a manufacturing system which does not include a printer (e.g., but otherwise requires precise positional control). The teachings described herein can be applied to any type of manufacturing or fabrication apparatus, including apparatuses which position tools, processing devices, depositions sources, inspection devices, and similar devices, e.g., where high precision is desired or necessary. The techniques described herein are also not limited to split-axis systems, e.g., while several embodiments described above feature separated transport mechanisms for x and y dimensions, it is possible to apply the techniques described herein to other types of position articulation systems (e.g., that rely on a gimbal or other non-linear transport path, or to a system that provides transport across multiple dimensions), or where different degrees of freedom are at issue. Third, while described techniques have been presented in the context of an assembly-line-style process, application of the described techniques are also not limited to this environment, e.g., they can be practiced in any type of manufacturing system, positioning system, non-industrial printer, or potentially another type of system or device.

Without limiting the foregoing, in one embodiment, adjustment is made offline, once to a manufacturing or fabrication apparatus or printer; in a different embodiment, adjustment can be made per-substrate or per-product to correct for misalignment or distortion. In still another embodiment, measurements can be taken dynamically and used to make adjustments in real time. Clearly, many variations exist without departing from the inventive principles described herein.

The foregoing description and in the accompanying drawings, specific terminology and drawing symbols have been set forth to provide a thorough understanding of the disclosed embodiments. In some instances, the terminology and symbols may imply specific details that are not required to practice those embodiments. The terms “exemplary” and “embodiment” are used to express an example, not a preference or requirement.

As indicated, various modifications and changes may be made to the embodiments presented herein without departing from the broader spirit and scope of the disclosure. For example, features or aspects of any of the embodiments may be applied, at least where practical, in combination with any other of the embodiments or in place of counterpart features or aspects thereof. Thus, for example, not all features are shown in each and every drawing and, for example, a feature or technique shown in accordance with the embodiment of one drawing should be assumed to be optionally employable as an element of, or in combination of, features of any other drawing or embodiment, even if not specifically called out in the specification. Accordingly, the specification and drawings are to be regarded in an illustrative rather than a restrictive sense.

1. (canceled)

2. A method of manufacturing a layer of an electronic product, the method comprising:
articulating a print head relative to a substrate while on-the-fly ejecting droplets of a liquid onto a first side of the substrate, to form a liquid coat, wherein the droplets of the liquid carry a film-forming-material; and
processing the liquid coat to solidify the film-forming-material relative to the liquid, to form the layer;
wherein the method further comprises measuring height of the print head from the first side of the substrate and adjusting droplet ejection parameters used for the ejecting in dependence on the measurement of the height.

3. The method of claim 2, wherein measuring the height comprises using a first sensor mounted in a manner that is fixed relative to the print head to measure a first distance between the first sensor and the first side of the substrate, and using a second sensor to measure a difference in height between the first sensor and at least one ejection orifice of the print head, and using an electronic circuit to digitally calculate the height in dependence on the first distance and the difference in height between the first sensor and the at least one ejection orifice.

4. The method of claim 3, wherein measuring the height comprises using the first sensor to calculate a second distance between the first sensor and a first surface of a calibration block, using the second sensor to calculate a third distance between the second sensor and a second surface of the calibration block, and using at least one processor to calculate a fourth distance between the first sensor and the second sensor based on the second distance, the third distance, and a known thickness of the calibration block between the first and second surfaces of the calibration block, and wherein the method further comprises calculating the difference in height between the first sensor and the at least one ejection orifice using the fourth distance.

5. The method of claim 3, embodied in a split-axis printing system, wherein articulating the print head relative to the substrate comprises using a print head transport carriage to transport a print head assembly along a first axis and using a transport system to transport the substrate along a second axis via engagement of the substrate with a gripper of the transport system, and wherein:
the method further comprises
moving the print head assembly along the first axis and moving the gripper along the second axis so as to image with a camera each of the print head and the first sensor, the camera being mounted in a fixed position relative to the gripper, and
identifying relative position of at least one nozzle of the print head and the first sensor according to position of the print head assembly along the first axis, position of the gripper along the second axis at time of image capture, and location of the respective at least one nozzle or first sensor within a captured image; and
adjusting the droplet ejection parameters is further performed on a respective basis for each of at least two respective nozzles in dependence on the identified relative position.

6. The method of claim 2, wherein measuring the height is performed using a camera mounted within a printing system, adjusting a focus of the camera to obtain a proper focus, and identifying the height depending on a focal length of the camera at the proper focus.

7. The method of claim 2, wherein measuring the height is performed using a laser sensor mounted within a printing system, and wherein the height is measured to a precision of one micron or less.

8. The method of claim 2, embodied in a split-axis printing system, wherein articulating the print head relative to the substrate comprises using a print head transport carriage to transport a print head assembly along a first axis and using a transport system to transport the substrate along a second axis via engagement of the substrate with a gripper of the transport system, and wherein the method further comprises moving the print head assembly along the first axis and moving the gripper along the second axis to identify a common reference point, and establishing a coordinate reference system in a manner where coordinates are dependent on the common reference point, a current position of the print head assembly along the first axis relative to the common reference point, and a current position of the gripper along the second axis relative to the common reference point.

9. The method of claim 2, wherein the method further comprises dynamically measuring variation in the height during the articulating of the print head above the substrate, and wherein the adjusting of the droplet ejection parameters comprises adjusting droplet the ejection parameters dependent on the measured variation.

10. The method of claim 9, wherein the substrate has a second side that is to be supported by a support structure during said articulating and on-the-fly ejecting, and wherein:
measuring the height further comprises
using a first sensor fixed relative to the support structure to measure a first distance between the first sensor and the print head,
using a second sensor fixed relative to the print head to measure a second distance between the second sensor and first side of substrate, and
using at least one processor to compute a third distance between the print head and the first side of the substrate, in dependence on the measured first distance and the measured second distance; and
the variation in height is dependent on the third distance.

11. The method of claim 10, wherein:
using the second sensor further comprises intermittently re-measuring the second distance during the articulation of the print head relative to the substrate, to obtain measurements at respective positions of the print head relative to the substrate;
using the at least one processor comprises calculating the variation dependent on the measurements at the respective positions; and
adjusting the droplet ejecting parameters further comprises adjusting a delay value to be applied to delay droplet firing by at least one nozzle of the print head in a manner dependent on a magnitude of the variation.

12. The method of claim 10, wherein:
using the second sensor further comprises intermittently re-measuring the second distance during the articulation of the print head relative to the substrate, to obtain measurements at respective positions of the print head relative to the substrate;
using the at least one processor comprises calculating the variation dependent on the measurements at the respective positions; and
adjusting the droplet ejecting parameters further comprises adjusting a nozzle firing waveform to be applied to droplet firing by at least one nozzle of the print head in a manner dependent on a magnitude of the variation.

13. The method of claim 10, wherein:
using the second sensor further comprises intermittently re-measuring the second distance during the articulation of the print head relative to the substrate, to obtain measurements at respective positions of the print head relative to the substrate;
using the at least one processor comprises calculating the variation dependent on the measurements at the respective positions; and
adjusting the droplet ejecting parameters further comprises adjusting a droplet velocity to be imparted by at least one nozzle of the print head in a manner dependent on a magnitude of the variation.

14. The method of claim 2, wherein adjusting the droplet ejection parameters comprises at least one of adjusting a nozzle delay value to be applied to delay firing of a droplet by a given nozzle, adjusting a droplet ejection velocity to be imparted to a droplet by the given nozzle, or adjusting a drive voltage used by the given nozzle to eject a droplet.

15. A method of manufacturing a layer of an electronic product, the method comprising:
articulating a print head relative to a substrate while on-the-fly ejecting droplets of a liquid onto a first side of the substrate, to form a liquid coat, wherein the droplets of the liquid carry a film-forming-material; and
processing the liquid coat to solidify the film-forming-material relative to the liquid, to form the layer;
wherein the method further comprises measuring height of the print head from the first side of the substrate dynamically during the articulating of the print head relative to the substrate and adjusting droplet ejection parameters used for the ejecting in dependence on the dynamic measurements of the height.

16. The method of claim 15, wherein adjusting the droplet ejection parameters is performed on a respective basis for each one of multiple nozzles of the print head, in a manner dependent on respective height of the one of the multiple nozzles at a time that the one of the multiple nozzles is to eject a droplet of the liquid onto the first side of the substrate.

17. The method of claim 15, wherein measuring the height comprises using a first sensor mounted in a manner that is fixed relative to the print head to measure a first distance between the first sensor and the first side of the substrate, and using a second sensor to measure a difference in height between the first sensor and at least one ejection orifice of the print head, and using an electronic circuit to digitally calculate the height in dependence on the first distance and the difference in height between the first sensor and the at least one ejection orifice.

18. The method of claim 17, wherein measuring the height comprises using the first sensor to calculate a second distance between the first sensor and a first surface of a calibration block, using the second sensor to calculate a third distance between the second sensor and a second surface of the calibration block, and using at least one processor to calculate a fourth distance between the first sensor and the second sensor based on the second distance, the third distance, and a known thickness of the calibration block between the first and second surfaces of the calibration block, and wherein the method further comprises calculating the difference in height between the first sensor and the at least one ejection orifice using the fourth distance.

19. The method of claim 17, embodied in a split-axis printing system, wherein articulating the print head relative to the substrate comprises using a print head transport carriage to transport a print head assembly along a first axis and using a transport system to transport the substrate along a second axis via engagement of the substrate with a gripper of the transport system, and wherein:
the method further comprises
moving the print head assembly along the first axis and moving the gripper along the second axis so as to image with a camera each of the print head and the first sensor, the camera being mounted in a fixed position relative to the gripper, and
identifying relative position of at least one nozzle of the print head and the first sensor according to position of the print head assembly along the first axis, position of the gripper along the second axis at time of image capture, and location of the respective at least one nozzle or first sensor within a captured image; and
adjusting the droplet ejection parameters is further performed on a respective basis for each of at least two respective nozzles in dependence on the identified relative position.

20. The method of claim 15, wherein measuring the height is performed using a camera mounted within a printing system, adjusting a focus of the camera to obtain a proper focus, and identifying the height depending on a focal length of the camera at the proper focus.

21. The method of claim 15, wherein measuring the height is performed using a laser sensor mounted within a printing system, and wherein the height is measured to a precision of one micron or less.

22. The method of claim 15, embodied in a split-axis printing system, wherein articulating the print head relative to the substrate comprises using a print head transport carriage to transport a print head assembly along a first axis and using a transport system to transport the substrate along a second axis via engagement of the substrate with a gripper of the transport system, and wherein the method further comprises moving the print head assembly along the first axis and moving the gripper along the second axis to identify a common reference point, and establishing a coordinate reference system in a manner where coordinates are dependent on the common reference point, a current position of the print head assembly along the first axis relative to the common reference point, and a current position of the gripper along the second axis relative to the common reference point.

23. The method of claim 15, wherein the substrate has a second side that is to be supported by a support structure during said articulating and on-the-fly ejecting, and wherein:
measuring the height further comprises
using a first sensor fixed relative to the support structure to measure a first distance between the first sensor and the print head,
using a second sensor fixed relative to the print head to measure a second distance between the second sensor and first side of substrate, and
using at least one processor to compute a third distance between the print head and the first side of the substrate, in dependence on the measured first distance and the measured second distance; and
the variation in height is dependent on the third distance.

24. The method of claim 23, wherein:
using the second sensor further comprises intermittently re-measuring the second distance during the articulation of the print head relative to the substrate, to obtain measurements at respective positions of the print head relative to the substrate;
using the at least one processor comprises calculating the variation dependent on the measurements at the respective positions; and
adjusting the droplet ejecting parameters further comprises adjusting a delay value to be applied to delay droplet firing by at least one nozzle of the print head in a manner dependent on a magnitude of the variation.

25. The method of claim 23, wherein:
using the second sensor further comprises intermittently re-measuring the second distance during the articulation of the print head relative to the substrate, to obtain measurements at respective positions of the print head relative to the substrate;
using the at least one processor comprises calculating the variation dependent on the measurements at the respective positions; and
adjusting the droplet ejecting parameters further comprises adjusting a nozzle firing waveform to be applied to droplet firing by at least one nozzle of the print head in a manner dependent on a magnitude of the variation.

26. The method of claim 23, wherein:
using the second sensor further comprises intermittently re-measuring the second distance during the articulation of the print head relative to the substrate, to obtain measurements at respective positions of the print head relative to the substrate;
using the at least one processor comprises calculating the variation dependent on the measurements at the respective positions; and
adjusting the droplet ejecting parameters further comprises adjusting a droplet velocity to be imparted by at least one nozzle of the print head in a manner dependent on a magnitude of the variation.

27. A method of manufacturing a layer of an electronic product, the method comprising:
articulating a print head relative to a substrate while on-the-fly ejecting droplets of a liquid onto a first side of the substrate, to form a liquid coat, wherein the droplets of the liquid carry a film-forming-material; and
processing the liquid coat to solidify the film-forming-material relative to the liquid, to form the layer;
wherein the method further comprises measuring height of the print head from the first side of the substrate dynamically during the articulating of the print head relative to the substrate and adjusting droplet ejection parameters for each one of multiple nozzles used for the ejecting in dependence on the dynamic measurements of the height, and in dependence on position of the one of the multiple nozzles relative to the substrate at a time when the one of the multiple nozzles is to eject a respective one of the droplets.

28. The method of claim 27, wherein adjusting the droplet ejection parameters for each one of the multiple nozzles comprises at least one of adjusting a nozzle delay value to be applied to delay firing of the respective one of the droplets by the one of the multiple nozzles nozzle, adjusting a droplet ejection velocity to be imparted to the respective one of the droplets by the one of the multiple nozzles, or adjusting a drive voltage used by the one of the multiple nozzles to eject the respective one of the droplets.
